(19) United States
(12) Patent Application Publication
(10) Pub. No.: US 2020/0011405 A1
(43) Pub. Date: Jan. 9, 2020

(54) BALL TYPE SPEED REDUCER

(71) Applicant: ENPLAS CORPORATION, Saitama (JP)

(72) Inventor: Yasushi KAJIWARA, Saitama (JP)

(21) Appl. No.: 16/482,472

(22) PCT Filed: Jan. 16, 2018
(86) PCT No.: PCT/JP2018/000888

§ 371 Date: Jul. 31, 2019

(30) Foreign Application Priority Data
Feb. 1, 2017 (JP) 2017-016770
Apr. 4, 2017 (JP) 2017-074304
Aug. 22, 2017 (JP) 2017-159318

(51) Int. Cl. F16H 25/06

(52) U.S. Cl. CPC F16H 25/06; F16H 2025/063

(57) ABSTRACT

A ball type speed reducer includes: an eccentric disk cam that turns integrally with an input-side rotating body; a shaking body shaken by the eccentric disk cam; a plurality of balls supported by the shaking body; a fixing member; a first output-side rotating body facing one side face of the fixing member; and a second output-side rotating body facing the other side face of the fixing member. A plurality of radial grooves guide the ball along the radial direction in the fixing member. A corrugated groove spirally guiding the ball along the circumferential direction is formed across the first output-side rotating body and the second output-side rotating body. The groove depth at the top of a wave of the corrugated groove is greater than that at the bottom of the wave, in an alternating manner on the first output-side rotating body side and the second output-side rotating body side.

### TECHNICAL FIELD

The present invention relates to a ball type speed reducer used for decelerating and transmitting rotation.

### BACKGROUND ART

In the prior art, a ball type speed reducer is used in a power transmission unit of various types of machines (such as an industrial robot or a steering angle variable type steering system) because it is small-sized and can obtain a larger reduction ratio, compared to a mechanical reduction gear.

FIGS. 35A and 35B are diagrams illustrating the ball type speed reducer 100 of the prior art. Note that FIG. 35A is a longitudinal cross-sectional view illustrating the ball type speed reducer 100 of the prior art, and FIG. 35B is a cross-sectional view taken along the line A18-A18 of FIG. 35A to illustrate the ball type speed reducer 100.

As illustrated in FIGS. 35A and 35B, the ball type speed reducer 100 has an eccentric rotating plate 104 installed in an outer circumference side of an eccentric cam 102 provided in an input shaft 101 by interposing a bearing 103, so that the eccentric rotating plate 104 is eccentrically driven by the eccentric cam 102. Further, in this ball type speed reducer 100, an output-side rotating body 105 coupled to an output shaft (not shown) is disposed in both inner sides of a radial direction of the eccentric rotating plate 104, and the input shaft 101 is relatively turnably supported by an inner circumference side of the output-side rotating body 105 by interposing a bearing 106. Further, in this ball type speed reducer 100, a fixing member 107 fixed to a part of an industrial robot or the like is disposed in both outer sides of the radial direction of the eccentric rotating plate 104 by interposing balls 108, and the output-side rotating body 105 is turnably supported by the inner circumference side of the fixing member 107 by interposing a bearing 110. In addition, the balls 108 interposed between the eccentric rotating plate 104 and the fixing member 107 are rollably engaged with a first corrugated groove (first cycloid groove formed in an epicycloid curve) 111 formed on a side face of the eccentric rotating plate 104 and a second corrugated groove (second cycloid groove formed in a hypocycloid curve) 112 formed on the inner side face (side face facing the eccentric rotating plate 104) of the fixing member 107 to connect the eccentric rotating plate 104 and the fixing member 107. Note that the number of waves of the second corrugated groove 112 is larger than the number of waves of the first corrugated groove 111 by two waves.

Further, the output-side rotating body 105 is connected to the eccentric rotating plate 104 by interposing an eccentricity absorption mechanism 113. The eccentricity absorption mechanism 113 allows the eccentric rotating plate 104 to make an eccentric motion against the output-side rotating body 105 (to absorb eccentricity of the eccentric rotating plate 104) and transmits rotation of the eccentric rotating plate 104 to the output-side rotating body 105. The eccentricity absorption mechanism 113 has a plurality of balls 114 interposed between the eccentric rotating plate 104 and the output-side rotating body 105, a driving annular groove 115 of the eccentric rotating plate 104 that rollably houses the balls 114, and a follower annular groove 116 of the output-side rotating body 105. The driving annular groove 115 and the follower annular groove 116 have shapes and sizes determined by considering the eccentric amount of the eccentric cam 102, and the eccentric rotating plate 104 allows a movement of the ball 114 for making eccentric rotation with respect to a rotation center of the input shaft 101 to turn the output-side rotating body 105 integrally with the eccentric rotating plate 104 by interposing the balls 114 (see Patent Document 1).

In such a ball type speed reducer 100 of the prior art, for example, when the number of waves of the first corrugated groove 111 of the eccentric rotating plate 104 is set to “N−2,” and the number of waves of the second corrugated groove 112 of the fixing member 107 is set to “N,” as the input shaft 101 is rotationally driven by a motor (not shown) or the like, the eccentric rotating plate 104 is eccentrically driven by the eccentric cam 102 of the input shaft 101, and the output-side rotating body 105 rotates integrally with the eccentric rotating plate 104 by interposing the eccentricity absorption mechanism 113. However, the output-side rotating body 105 rotates by “−2/(N−2)” for one rotation of the input shaft 101 (rotation by “2/(N−2)” oppositely to the rotational direction of the input shaft 101). That is, the ball type speed reducer 100 of the prior art has a reduction ratio of “2/(N−2)” when the number of waves of the first corrugated groove 111 of the eccentric rotating plate 104 is set to “N−2,” and the number of waves of the second corrugated groove 112 of the fixing member 107 is set to “N.”

### CITATION LIST

### Patent Documents

Patent Document 1: Japanese Unexamined Patent Application Publication No. 5-10400

### SUMMARY OF INVENTION

However, in the ball type speed reducer 100 of the prior art illustrated in FIGS. 35A and 35B, the first corrugated groove 111 is formed in both side faces of the eccentric rotating plate 104, and the second corrugated groove 112 is formed on the inner side face of the fixing member 107 disposed in both sides of the eccentric rotating plate 104. Therefore, it is necessary to form the corrugated grooves 111, 111, 112 and 112 in a total of four side faces (four places) with high accuracy, and this increases man-hours disadvantageously.

Further, in the ball type speed reducer 100 of the prior art illustrated in FIGS. 35A and 35B, in order to turn the eccentric rotating plate 104 and the output-side rotating body 105 integrally, the output-side rotating body 105 is connected to the eccentric rotating plate 104 by interposing the eccentricity absorption mechanism 113. Therefore, it has a complicated structure, and increases man-hours disadvantageously.

In view of the aforementioned problems, it is therefore an object of the present invention to provide a ball type speed reducer having a simple structure and reduced man-hours.

### Solution to Problem

The present invention relates to a ball type speed reducer 1 that decelerates and transmits rotation of an input-side rotating body (2, 3) to an output-side rotating body 8. The ball type speed reducer 1 of the present invention includes: an eccentric disk cam 4 turning integrally with the input-side rotating body (2, 3); a shaking body 5 fitted relatively turnably to an outer circumference side of the eccentric disk cam 4 and shaken by the eccentric disk cam 4; a plurality of balls 6 disposed along an outer circumferential surface 5b of the shaking body 5; a fixing member 7 housing the shaking body 5 in an inner side of a radial direction such that the shaking body 5 is shakable and fixed to a fixation target member; a first output-side rotating body 8A disposed to face one side face of the shaking body 5 and the fixing member 7 and relatively turnably supported by the input-side rotating body (2, 3); and a second output-side rotating body 8B disposed to face the other side face of the shaking body 5 and the fixing member 7 and integrally turnably fixed to the first output-side rotating body 8A, and relatively turnably supported by the input-side rotating body (2, 3) and constituting the output-side rotating body 8 together with the first output-side rotating body 8A. In addition, the outer circumferential surface 5b of the shaking body 5 is a cylindrical surface concentric with a center 4a of the eccentric disk cam 4. Further, when a direction extending radially from a rotation center 2a of the input-side rotating body (2, 3) is set as a radial direction on a virtual plane perpendicular to the rotation center 2a, the fixing member 7 has a plurality of radial grooves 38 as many as the balls 6 formed to slidably guide the balls 6 in the radial direction, and radial inner ends of the radial grooves 38 are open ends allowing the balls 6 to enter and exit. Further, the first output-side rotating body 8A has a first side face portion 32 opposed to one side face of the fixing member 7. Further, the second output-side rotating body 8B has a second side face portion 41 opposed to the other side face of the fixing member 7. Further, when a direction extending along an outer edge of a virtual circle centered at the rotation center 2a on the virtual plane is set as a circumferential direction, the first side face portion 32 and the second side face portion 41 each have annular corrugated grooves 40, 56, 60 formed to spirally guide the balls 6 along the circumferential direction.

### Advantageous Effects of Invention

The ball type speed reducer according to the present invention has the corrugated groove formed only in two places: at the first side face portions of the first output-side rotating body and the second side face portions of the second output-side rotating body, which face the shaking body and the fixing member. Therefore, it is possible to reduce the man-hours, compared to the prior art in which the corrugated groove is formed in each of four side faces. Further, the ball type speed reducer according to the present invention has the shaking body that can be shaken independently from the output-side rotating body (the first output-side rotating body and the second output-side rotating body) and the fixing member. Therefore, it is not necessary to provide a complicated mechanism for turning the output-side rotating body and the shaking body integrally. Accordingly, it is possible to simplify the structure and reduce the man-hours.

### BRIEF DESCRIPTION OF DRAWINGS

FIG. 1 is a longitudinal cross-sectional view illustrating a ball type speed reducer according to a first embodiment of the invention.

FIGS. 2A-2C are diagrams illustrating an input shaft (input-side rotating body) of a ball type speed reducer according to a first embodiment of the invention, in which FIG. 2A is a front view illustrating the input shaft (view illustrating a leading end face), FIG. 2B is a side view illustrating the input shaft, and FIG. 2C is a view illustrating a trailing end face of the input shaft.

FIGS. 3A-3C are diagrams illustrating a cap (input-side rotating body) of the ball type speed reducer according to the first embodiment of the invention, in which FIG. 3A is a front view illustrating the cap, FIG. 3B is a cross-sectional view taken along the line A1-A1 of FIG. 3A to illustrate the cap, and FIG. 3C is a rear view illustrating the cap.

FIGS. 4A and 4B are diagrams illustrating a shaking body of the ball type speed reducer according to the first embodiment of the invention, in which FIG. 4A is a front view illustrating the shaking body, and FIG. 4B is a cross-sectional view taken along the line A2-A2 of FIG. 4A to illustrate the shaking body.

FIGS. 5A and 5B are diagrams illustrating a fixing member of the ball type speed reducer according to the first embodiment of the invention, in which FIG. 5A is a front view illustrating the fixing member, and FIG. 5B is a cross-sectional view taken along the line A3-A3 of FIG. 5A to illustrate the fixing member.

FIGS. 6A and 6B are diagrams illustrating a first output-side rotating body of the ball type speed reducer according to the first embodiment of the invention, in which FIG. 6A is a front view illustrating the first output-side rotating body, and FIG. 6B is a cross-sectional view taken along the line A4-A4 of FIG. 6A to illustrate the first output-side rotating body.

FIGS. 7A and 7B are diagrams illustrating a second output-side rotating body of the ball type speed reducer according to the first embodiment of the invention, in which FIG. 7A is a front view illustrating the second output-side rotating body, and FIG. 7B is a cross-sectional view taken along the line A5-A5 of FIG. 7A to illustrate the second output-side rotating body.

FIG. 8 is a perspective view illustrating a corrugated groove of the ball type speed reducer according to the first embodiment of the invention in a simplified manner.

FIGS. 9A and 9B are diagrams illustrating a rolling trajectory of a ball when the ball is rolled in the corrugated groove, in which FIG. 9A is a plan view of the rolling trajectory of the ball, and FIG. 9B is a diagram illustrating waves whose rolling trajectory is projected on a virtual cross section taken along the line A6-A6 of FIG. 9A.

FIGS. 10A and 10B illustrate an explanatory diagram of a first modification of the corrugated groove in FIG. 10A, and an explanatory diagram of a second modification of the corrugated groove in FIG. 10B.

FIG. 11 is a longitudinal cross-sectional view illustrating a ball type speed reducer according to a second embodiment of the invention.

FIGS. 12A and 12B illustrate a front view of the first output-side rotating body in FIG. 12A, and a cross-sectional view taken along the line A7-A7 of FIG. 12A to illustrate the first output-side rotating body in FIG. 12B.

FIGS. 13A and 13B illustrate a front view of the second output-side rotating body in FIG. 13A, and a cross-sectional view taken along the line A8-A8 of FIG. 13A to illustrate the second output-side rotating body in FIG. 13B.

FIG. 14 is a longitudinal cross-sectional view illustrating a ball type speed reducer according to a third embodiment of the invention.

FIG. 15 is a front view illustrating the ball type speed reducer according to the third embodiment of the invention in which a cap and a second output-side rotating body are removed.

FIGS. 16A-16C are diagrams illustrating an input shaft (input-side rotating body) of the ball type speed reducer according to the third embodiment of the invention, in which FIG. 16A is a front view illustrating the input shaft (view illustrating a leading end face), FIG. 16B is a side view illustrating the input shaft, and FIG. 16C is a cross-sectional view taken along the line A9-A9 of FIG. 16A.

FIGS. 17A-17C are diagrams illustrating a cap (input-side rotating body) of the ball type speed reducer according to the third embodiment of the invention, in which FIG. 17A is a front view illustrating the cap, FIG. 17B is a side view illustrating the cap, and FIG. 17C is a cross-sectional view taken along the line A10-A10 of FIG. 17A to illustrate the cap.

FIGS. 18A and 18B are diagrams illustrating a shaking body of the ball type speed reducer according to the third embodiment of the invention, in which FIG. 18A is a front view illustrating the shaking body, and FIG. 18A is a cross-sectional view taken along the line A11-A11 of FIG. 18A to illustrate the shaking body.

FIGS. 19A and 19B are diagrams illustrating a fixing member of the ball type speed reducer according to the third embodiment of the invention, in which FIG. 19A is a front view illustrating the fixing member, and FIG. 19B is a cross-sectional view taken along the line A12-A12 of FIG. 19A to illustrate the fixing member.

FIGS. 20A-20C are diagrams illustrating a first output-side rotating body of the ball type speed reducer according to the third embodiment of the invention, in which FIG. 20A is a front view illustrating the first output-side rotating body, FIG. 20B is a side view illustrating the first output-side rotating body, and FIG. 20C is a cross-sectional view taken along the line A13-A13 of FIG. 20A to illustrate the first output-side rotating body.

FIGS. 21A-21C are diagrams illustrating a second output-side rotating body of the ball type speed reducer according to the third embodiment of the invention, in which FIG. 21A is a front view illustrating the second output-side rotating body, FIG. 21B is a side view illustrating the second output-side rotating body, and FIG. 21C is a cross-sectional view taken along the line A14-A14 of FIG. 21A to illustrate the second output-side rotating body.

FIGS. 22A-22C are diagrams illustrating a rolling trajectory of a ball when the ball is rolled in a corrugated groove of the ball type speed reducer according to the third embodiment of the invention, in which FIG. 22A is a plan view illustrating the rolling trajectory of the ball, FIG. 22B is a diagram illustrating waves whose rolling trajectory is projected on a virtual cross section taken along the line A15-A15 of FIG. 22A, and FIG. 22C is an enlarged view illustrating the rolling trajectory of the ball of FIG. 22B.

FIGS. 23A and 23B are diagrams illustrating a feature of the corrugated groove of the ball type speed reducer according to the third embodiment of the invention, in which FIG. 23A illustrates an arrangement in which balls are located at the top in a rolling trajectory of the ball, and FIG. 23B is a cylindrical cross-sectional view taken at the position corresponding to the line A16-A16 of FIG. 23B to illustrate the ball type speed reducer.

FIGS. 24A and 24B are diagrams illustrating a feature of the corrugated groove of the ball type speed reducer according to the third embodiment of the invention, in which FIG. 24A illustrates an arrangement in which balls are located at a middle position between the top and the bottom in a rolling trajectory of the ball, and FIG. 24B is a cylindrical cross-sectional view taken at the position corresponding to the line A17-A17 of FIG. 24A to illustrate the ball type speed reducer.

FIGS. 25A and 25B illustrate a diagram (corresponding to FIG. 22C) illustrating a rolling trajectory of a ball according to a first modification of the third embodiment of the invention in FIG. 25A, and a diagram (corresponding to FIG. 22C) illustrating a rolling trajectory of a ball according to a second modification of the third embodiment of the invention in FIG. 25A.

FIGS. 26A and 26B are diagrams illustrating a ball type speed reducer according to a fourth embodiment of the invention, in which FIG. 26A is a front view illustrating the ball type speed reducer, and FIG. 26B is a side view illustrating the ball type speed reducer.

FIG. 27 is a cross-sectional view taken along the line A18-A18 of FIG. 26A to illustrate the ball type speed reducer.

FIG. 28 is a front view illustrating the ball type speed reducer according to the fourth embodiment of the invention in which a cap and a second output-side rotating body are removed.

FIGS. 29A-29D are diagrams illustrating an input shaft (input-side rotating body) of the ball type speed reducer according to the fourth embodiment of the invention, in which FIG. 29A is a front view illustrating the input shaft (view illustrating a leading end face), FIG. 29B is a side view illustrating the input shaft, FIG. 29C is a rear view illustrating the input shaft (view illustrating a trailing end face), and FIG. 29D is a cross-sectional view taken along the line A19-A19 of FIG. 29A.

FIGS. 30A-30D are diagrams illustrating the cap (input-side rotating body) of the ball type speed reducer according to the fourth embodiment of the invention, in which FIG. 30A is a front view illustrating the cap, FIG. 30B is a side view illustrating the cap, FIG. 30C is a rear view illustrating the cap, and FIG. 30D is a cross-sectional view taken along the line A20-A20 of FIG. 30A to illustrate the cap.

FIGS. 31A-31F are diagrams illustrating a modification of a shaking body of the ball type speed reducer according to the fourth embodiment of the invention, in which FIG. 31A is a front view illustrating the shaking body, FIG. 31B is a side view illustrating the shaking body, FIG. 31C is a rear view illustrating the shaking body, FIG. 31D is a cross-sectional view taken along the line A21-A21 of FIG. 31A to illustrate the shaking body, FIG. 31E is an enlarged view illustrating the section B1 of FIG. 31B, and FIG. 31F is a diagram illustrating the shaking body engaging a ball.

FIGS. 32A-32F are diagrams illustrating a fixing member of the ball type speed reducer according to the fourth embodiment of the invention, in which FIG. 32A is a front view illustrating the fixing member, FIG. 32B is a side view illustrating the fixing member, FIG. 32C is a rear view illustrating the fixing member, FIG. 32D is a cross-sectional view taken along the line A22-A22 of FIG. 32A to illustrate the fixing member, FIG. 32E is an enlarged view illustrating the section B2 of FIG. 32A, and FIG. 32F is a cross-sectional view taken along the line A23-A23 of FIG. 32E.

FIGS. 33A-33D are diagrams illustrating a first output-side rotating body of the ball type speed reducer according to the fourth embodiment of the invention, in which FIG. 33A is a front view illustrating the first output-side rotating body in which a corrugated groove is formed, FIG. 33B is a side view illustrating the first output-side rotating body, FIG. 33C is a cross-sectional view taken along the line A24-A24 of FIG. 33A to illustrate the first output-side rotating body, and FIG. 33D is a rear view illustrating the first output-side rotating body.

FIGS. 34A-34D are diagrams illustrating a second output-side rotating body of the ball type speed reducer according to the fourth embodiment of the invention, in which FIG. 34A is a front view illustrating the second output-side rotating body in which a corrugated groove is formed, FIG. 34B is a side view illustrating the second output-side rotating body, FIG. 34C is a cross-sectional view taken along the line A25-A25 of FIG. 34A to illustrate the second output-side rotating body, and FIG. 34D is a rear view illustrating the second output-side rotating body.

FIGS. 35A and 35B are diagrams illustrating a ball type speed reducer of the prior art, in which FIG. 35A is a longitudinal cross-sectional view illustrating the ball type speed reducer, and FIG. 35B is a cross-sectional view taken along the line A26-A26 of FIG. 35A.

### DESCRIPTION OF EMBODIMENTS

Embodiments of the present invention will now be described with reference to the accompanying drawings.

### First Embodiment

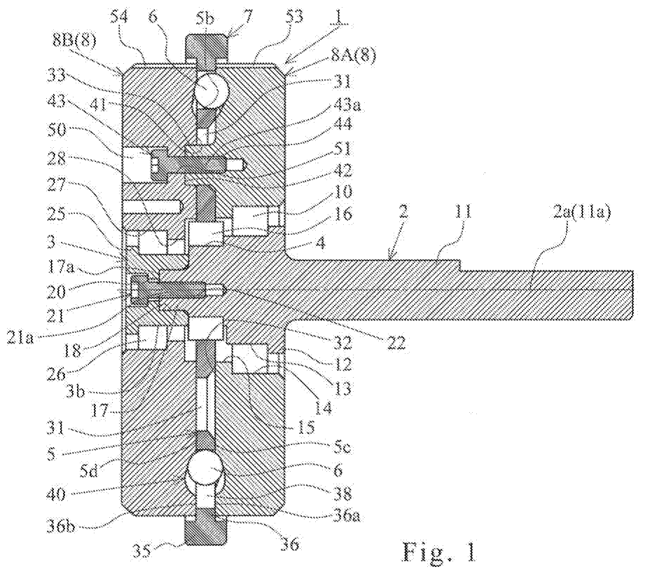

FIG. 1 is a longitudinal cross-sectional view illustrating a ball type speed reducer 1 according to a first embodiment of the invention. As illustrated in FIG. 1, the ball type speed reducer 1 according to this embodiment includes an input shaft (input-side rotating body) 2, a cap (input-side rotating body) 3, an eccentric disk cam 4, a shaking body 5, a plurality of balls (steel balls) 6, a fixing member 7, an output-side rotating body 8 (a first output-side rotating body 8A and a second output-side rotating body 8B), and the like.

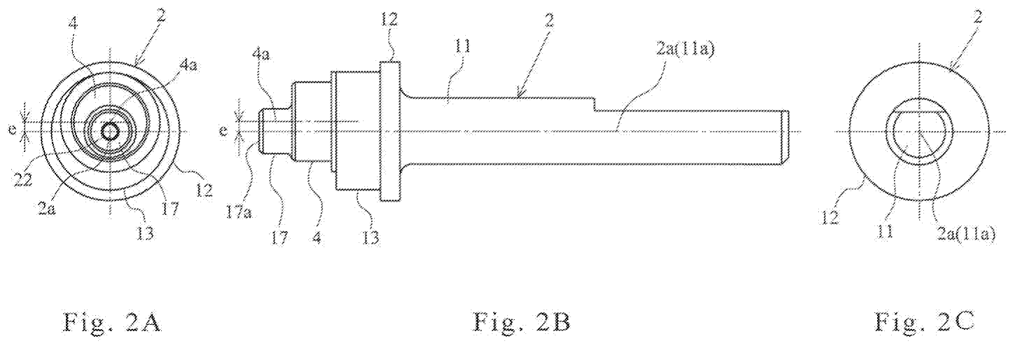

As illustrated in FIGS. 1-2C, the input shaft 2 turnably supports the first output-side rotating body 8A by interposing a first bearing 10, so that the input shaft 2 is rotationally driven by a motor or the like (not shown). The input shaft 2 is formed such that a flange-like portion 12 having a diameter larger than that of a shaft body portion 11 is adjacent to the shaft body portion 11. A bearing support portion 13 is formed adjacent to the flange-like portion 12. The first bearing 10 is attached to the bearing support portion 13 to hold the first bearing 10 between an inner protrusion 15 of a bearing hole 14 of the first output-side rotating body 8A and the flange-like portion 12. Further, the input shaft 2 has the eccentric disk cam 4 formed closer to a shaft tip side than the bearing support portion 13 and in the vicinity of the bearing support portion 13. This eccentric disk cam 4 is a decentered shaft portion having a center 4a decentered from a rotation center 2a of the input shaft 2 (a rotation center 11a of the shaft body portion 11) by an eccentric amount “e,” and is eccentrically rotated integrally with the input shaft 2 by virtue of rotation of the rotation center 2a of the input shaft 2. In addition, the shaking body 5 is relatively turnably installed in the outer circumference side of the eccentric disk cam 4 by interposing a second bearing 16. Further, the input shaft 2 has a tip shaft portion 17 formed to install the cap 3. The tip shaft portion 17 has a rotation center concentric with the rotation center 2a of the shaft body portion 2 and fitted in a shaft hole 18 of the cap 3 and has a leading end face 17a abutting on a stopper protrusion 20 protruding into the shaft hole 18 of the cap 3. Further, in the tip shaft portion 17 of the input shaft 2, a screw hole (female screw) 22 to be screwed with a screw shaft portion 21a of a bolt 21 for fixing the cap 3 is formed. Note that, in the following description, considering a virtual plane perpendicular to the rotation center 2a of the input shaft 2, it is assumed that a radial direction refers to a direction extending radially from the rotation center 2a on the virtual plane. Further, considering the virtual plane perpendicular to the rotation center 2a of the input shaft 2, it is assumed that a circumferential direction refers to a direction along an outer edge of a virtual circle centered at the rotation center 2a of the input shaft 2.

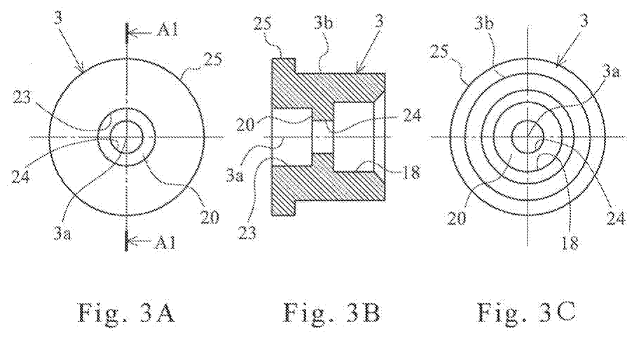

As shown in FIGS. 1 and 3A-3C, the cap 3 is fixed to the tip shaft portion 17 of the input shaft 2 with the bolt 21, constitutes an input-side rotating body together with the input shaft 2, and has a rotation center 3a coinciding with the rotation center 2a of the input shaft 2. The cap 3 has the shaft hole 18 opened at one end side (right end side in FIG. 3B) along the rotation center 3a, a bolt head housing hole 23 opened at the other end side along the rotation center 3a (left end side in FIG. 3B), and a bolt shaft insertion hole 24 through which the bolt head housing hole 23 and the shaft hole 18 are communicated with each other. Further, the cap 3 has a ring-shaped bearing stopper 25 on one end side of a cylindrical outer circumferential surface 3b. A side face of a third bearing 26 attached to the outer circumferential surface 3b abuts on the bearing stopper 25, so that the third bearing 26 is held between an inner protrusion 28 in a bearing hole 27 of the second output-side rotating body 8B and the bearing stopper 25. Note that, in the cap 3, the rotation center of the shaft hole 18 and the rotation center of the outer circumferential surface 3b are concentric with the rotation center 3a of the cap 3.

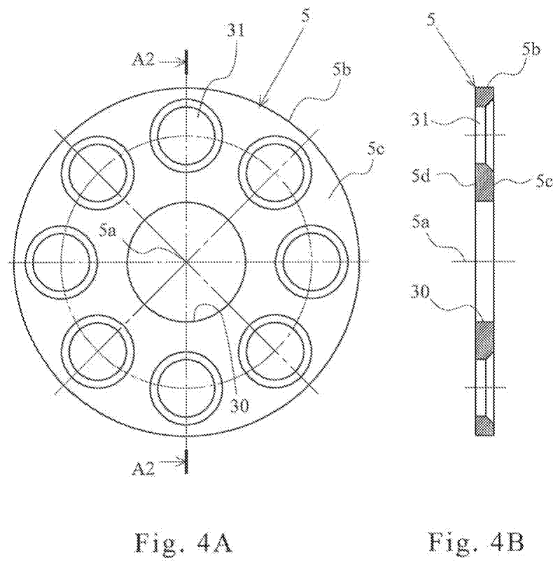

As shown in FIGS. 1 and 4A-4B, the shaking body 5 is formed in a disk shape so as to be shaken by the eccentric disk cam 4, has a central bearing hole 30 fitted to the outer circumferential surface of the second bearing 16, and is supported by the second bearing 16 so as to be able to turn relative to the eccentric disk cam 4. In the shaking body 5, a center 5a is formed so as to be concentric with the center 4a of the eccentric disk cam 4, and an outer circumferential surface 5b is a cylindrical surface concentric with the center 4a of the eccentric disk cam 4. The plurality of balls 6 are rotatably supported at the outer circumferential surface 5b. Further, in the shaking body 5, eight through holes 31 are formed at equal intervals along the circumferential direction on an outer side of the radial direction of the bearing hole 30. The through hole 31 of the shaking body 5 is engaged with a coupling protrusion 33 formed on a first side face portion 32 of the first output-side rotating body 8A with a gap therebetween, and is formed to have a size such that the through hole 31 does not contact the coupling protrusion 33 even when the shaking body 5 is shaken by the eccentric disk cam 4.

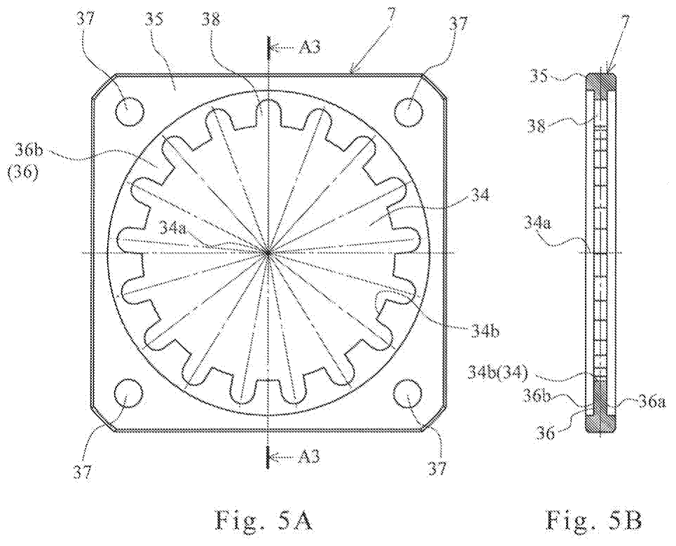

As shown in FIGS. 1 and 5A-5B, the fixing member 7 has a substantially square shape on the front side, and a shaking body housing hole 34 is formed in its central portion. The fixing member 7 has a fixing frame portion 35 formed along the outer edge, and a radial groove forming disk portion 36 formed on the inner side of the radial direction of the fixing frame portion 35. In addition, in the fixing member 7, bolt holes 37 are formed at four corners of the fixing frame portion 35. Fixing bolts (not shown) are inserted into the bolt holes 37 in the four places, so that the fixing member 7 is fixed to a fixation target member (not shown) (for example, a machine frame or a robot arm) by the fixing bolts. The fixing member 7 is fixed to the fixation target member such that a center 34a of the shaking body housing hole 34 is concentric with the rotation center 2a of the input shaft 2. In addition, the shaking body 5 is housed in the shaking body housing hole 34 of the fixing member 7 so as to be able to be shaken. Further, in the fixing member 7, a plurality of radial grooves 38 extending along the radial direction from an inner circumferential surface 34b of the shaking body housing hole 34 are formed along the circumferential direction at equal intervals (in “(N+1)/3” places when the number of waves of a corrugated groove 40 is set to “N”). The radial groove 38 is an open end whose radial inner end allows the ball 6 to enter and exit, has a groove width slightly larger than the diameter of the ball 6, and has a groove length (length in the radial direction) which is a length taking into consideration the amount of shaking of the shaking body 5 (the eccentric amount e of the eccentric disk cam 4), so that the ball 6 supported at the outer circumferential surface 5b of the shaking body 5 is slidably moved along the radial direction. Further, in the fixing member 7, a plate thickness of the radial groove forming disk portion 36 is formed smaller than the diameter of the ball 6, so that the ball 6 is uniformly protruded on both sides of the radial groove forming disk portion 36 and the ball 6 in the radial groove 38 is rollably engaged with the corrugated groove 40 formed in the output-side rotating body 8 when the center of the ball 6 engaged with the radial groove 38 is aligned with the center position in the thickness direction of the radial groove forming disk portion 36. Such radial grooves 30 of the fixing member 7 can roll the balls 6 in the radial direction depending on a shake amount of the shaking body 5 as the eccentric disk cam 4 rotates by one turn, and the shaking body 5 is shaken by one stroke. Note that, in this embodiment, the plate thickness of the radial groove forming disk portion 36 of the fixing member 7 is the same as the plate thickness of the shaking body 5.

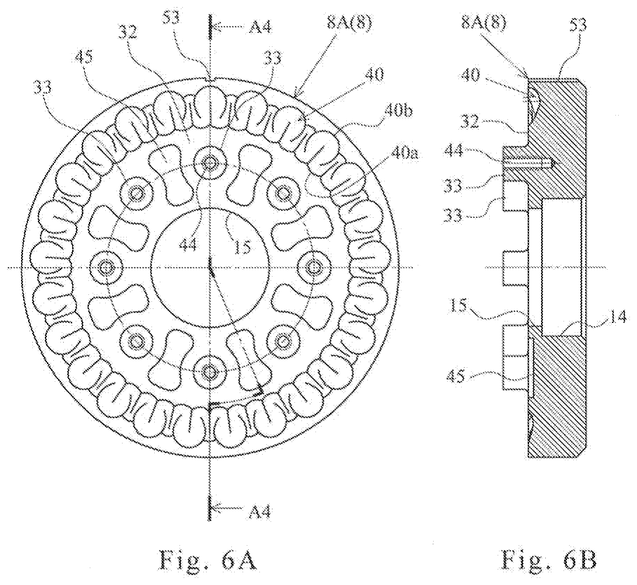

As shown in FIGS. 1 and 6A-6B, the first output-side rotating body 8A has the first side face portion 32 placed to face one side face 5c of both side faces 5c and 5d of the shaking body 5, and one side face 36a of both side faces 36a and 36b of the radial groove forming disk portion 36 of the fixing member 7. Further, in the first output-side rotating body 8A, the bearing hole 14 for housing the first bearing 10 attached to the input shaft 2 is formed, so that the side face of the outer race of the first bearing 10 abuts on the inner protrusion 15 formed at the end of the bearing hole 14. In the first side face portion 32 of the first output-side rotating body 8A, a plurality of coupling protrusions 33 for coupling and fixing the second output-side rotating body 8B are formed at equal intervals (in eight places) in the circumferential direction. The coupling protrusion 33 is inserted into the through hole 31 of the shaking body 5 so as to be fitted in a coupling protrusion housing recess 42 formed on a second side face portion 41 of the second output-side rotating body 8B. In addition, in the coupling protrusion 33, a screw hole (female screw) 44 for fixing the second output-side rotating body 8B with a bolt 43 is formed. Further, in the first side face portion 32 of the first output-side rotating body 8A, a contact relief recess 45 is formed between the adjacent coupling protrusions 33, 33, and a lubricant such as grease is suitably contained in the contact relief recess 45. Further, in the first side face portion 32 of the first output-side rotating body 8A, the corrugated groove 40 is formed on the outer side of the radial direction of the coupling protrusion 33 and the contact relief recess 45.

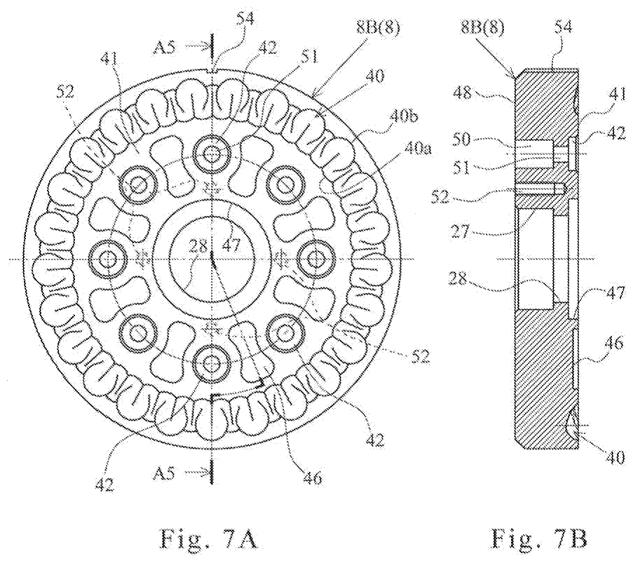

As shown in FIGS. 1 and 7A-7B, the second output-side rotating body 8B has the second side face portion 41 placed to face the other side face 5d of both the side faces 5c and 5d of the shaking body 5, and the other side face 36b of both the side faces 36a and 36b of the radial groove forming disk portion 36 of the fixing member 7. In the second side face portion 41 of the second output-side rotating body 8B, a plurality of the coupling protrusion housing recesses 42 in which the coupling protrusions 33 are fitted are formed as many as the coupling protrusions 33 at positions facing the respective coupling protrusions 33 of the first output-side rotating body 8A. Further, in the second side face portion 41 of the second output-side rotating body 8B, a contact relief recess 46 is formed between the adjacent coupling protrusion housing recesses 42, 42, and a lubricant such as grease is suitably contained in the contact relief recess 46. Further, in the second output-side rotating body 8B, the bearing hole 27 for housing the third bearing 26 attached to the cap 3 is formed, so that the side face of the outer race of the third bearing 26 abuts on the inner protrusion 28 formed at the end of the bearing hole 27. Further, in the second output-side rotating body 8B, a relief hole 47 for avoiding contact with the second bearing 16 is formed on the inner side of the radial direction on the second side face portion 41 side. Further, in the second side face portion 41 of the second output-side rotating body 8B, the corrugated groove 40 is formed on the outer side of the radial direction of the coupling protrusion housing recess 42 and the contact relief recess 46. Further, in the second output-side rotating body 8B, a bolt head housing recess 50 opened at a side face 48 placed opposite to the second side face portion 41 is formed at a position facing the coupling protrusion 33 of the first output-side rotating body 8A, and a bolt hole 51 through which the bolt head housing recess 50 and the coupling protrusion housing recess 42 are communicated with each other is formed. In addition, in the second output-side rotating body 8B, a screw shaft portion 43a of the bolt 43 inserted into the bolt head housing recess 50 and the bolt hole 51 is screwed into the screw hole 44 of the coupling protrusion 33 of the first output-side rotating body 8A, so that the second output-side rotating body 8B is fixed to the first output-side rotating body 8A, and is integrated with the first output-side rotating body 8A to constitute the output-side rotating body 8. Note that, in the second output-side rotating body 8B, a plurality of screw holes 52 are formed along the circumferential direction at a position radially inward of the bolt head housing recess 50 on the side face 48 opposite to the second side face portion 41, so that a rotation target member (not shown) to be turned by the second output-side rotating body 8B is fixed with a plurality of bolts (not shown) screwed into the plurality of screw holes 52.

As shown in FIGS. 1, 6A-6B, 7A-7B. and 8, the corrugated groove 40 is formed across the first side face portion 32 of the first output-side rotating body 8A and the second side face portion 41 of the second output-side rotating body 8B, and an even number (“N”=50) of waves are continuously formed annularly around the rotation center 2a of the input shaft 2, so that the corrugated groove 40 is rollably engaged with the balls 6 housed in the radial groove 38 of the fixing member in “(N+1)/3” places (17 places). When the corrugated groove 40 is formed to have waves in which a portion located at a radial inner end of a wave is referred to as a bottom 40a and a portion located at a radial outer end of the wave is referred to as a top 40b, the bottom 40a is formed across the first side face portion 32 of the first output-side rotating body 8A and the second side face portion 41 of the second output-side rotating body 8B. The top 40b of odd-numbered waves is formed to have a groove depth such that any one side of the first side face portion 32 and the second side face portion 41 is deeper than the other side of the first side face portion 32 and the second side face portion 41, the top 40b of even-numbered waves is formed to have a groove depth such that the other side of the first side face portion 32 and the second side face portion 41 is deeper than the one side of the first side face portion 32 and the second side face portion 41, and the groove depth is formed to gradually increase from the bottom 40a toward the top 40b. That is, the corrugated groove 40 has a shape similar to “offset teeth” of a saw blade. When moving along the radial direction in the radial groove 38, the ball 6, which is engaged with the corrugated groove 40 of the first output-side rotating body 8A, the corrugated groove 40 of the second output-side rotating body 8B, and also the radial groove 38 of the fixing member 7, is also moved in the direction along the rotation center 2a of the input shaft 2 by following the three-dimensionally formed corrugated groove 40. Note that, although the corrugated groove 40 is formed across the first side face portion 32 of the first output-side rotating body 8A and the second side face portion 41 of the second output-side rotating body 8B as described above, the corrugated groove 40 is shaped with high precision without any deviation between the corrugated groove 40 on the first output-side rotating body 8A side and the corrugated groove 40 on the second output-side rotating body 8B side. This is because when the first output-side rotating body 8A and the second output-side rotating body 8B are fixed, the first output-side rotating body 8A and the second output-side rotating body 8B are in a state of being positioned with high accuracy by aligning a positioning groove 53 of the first output-side rotating body 8A with a positioning groove 54 of the second output-side rotating body 8B (see FIGS. 1, 6A-6B, and 7A-7B).

FIGS. 9A and 9B are diagrams illustrating a rolling trajectory 55 of the ball 6 when the ball 6 is rolled in the corrugated groove 40. Note that FIG. 9A is a plan view illustrating the rolling trajectory 55 of the ball 6 (rolling trajectory 55 projected on a virtual plane perpendicular to the rotation center 2a of the input shaft 2). FIG. 9B is a diagram illustrating waves W1 and W2 of adjacent rolling trajectories projected on a virtual cross section taken along the line A6-A6 of FIG. 9A. In addition, the rolling trajectory 55 of the ball 6 shown in FIGS. 9A and 9B indicates a groove shape of the corrugated groove 40. Further, in FIGS. 9A and 9B, R represents the radial direction, and Z represents the direction along the rotation center 2a of the input shaft 2.

As shown in FIGS. 9A and 9B, in the rolling trajectory 55 of the ball 6, the first wave W1 of the waves W1 and W2 of the rolling trajectories 55 adjacent to each other is inclined from the bottom 40a to the top 40b of the corrugated groove 40 in the −Z direction at a constant rate. On the other hand, the second wave W2 of the rolling trajectory 55 is inclined from the bottom 40a to the top 40b of the corrugated groove 40 in the +Z direction at a constant rate. In addition, the amount of movement of the first wave W1 in the −Z direction is the same as the amount of movement of the second wave W2 in the +Z direction. Note that, for example, the corrugated groove 40 which forms the first wave W1 of the rolling trajectory 55 is formed such that a portion corresponding to the top 40b is deeper on the first side face portion 32 side of the first output-side rotating body 8A. In contrast to the first wave W1, the corrugated groove 40 which forms the second wave W2 of the rolling trajectory 55 is formed such that a portion corresponding to the top 40b is deeper on the second side face portion 41 side of the second output-side rotating body 8B.

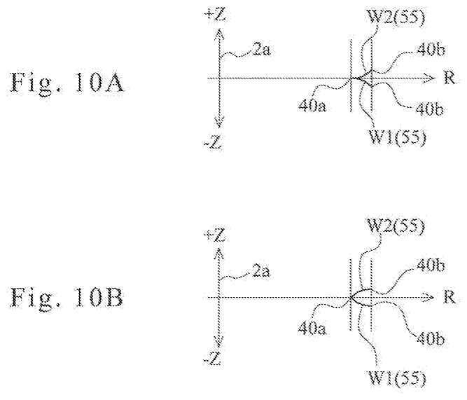

FIG. 10A is a diagram illustrating a first modification of the corrugated groove 40, and corresponding to FIG. 9B. In the rolling trajectory 55 of the ball 6 shown in FIG. 10A, the first wave W1 of the waves W1 and W2 of the rolling trajectories 55 adjacent to each other has a moving rate increased from the bottom 40a to the top 40b of the corrugated groove 40 in the −Z direction (as the ball 6 moves from radially inward to radially outward). On the other hand, the second wave W2 of the rolling trajectory 55 has a moving rate increased from the bottom 40a to the top 40b of the corrugated groove 40 in the +Z direction (as the ball 6 moves from radially inward to radially outward). The corrugated groove 40 may be formed to have the rolling trajectory 55 of the ball 6 shown in FIG. 10A.

FIG. 10B is a diagram illustrating a second modification of the corrugated groove 40, and corresponding to FIG. 9B. In the rolling trajectory 55 of the ball 6 shown in FIG. 10B, the first wave W1 of the waves W1 and W2 of the rolling trajectories 55 adjacent to each other has a moving rate decreased from the bottom 40a to the top 40b of the corrugated groove 40 in the −Z direction (as the ball 6 moves from radially inward to radially outward). On the other hand, the second wave W2 of the rolling trajectory 55 has a moving rate decreased from the bottom 40a to the top 40b of the corrugated groove 40 in the +Z direction (as the ball 6 moves from radially inward to radially outward). The corrugated groove 40 may be formed to have the rolling trajectory 55 of the ball 6 shown in FIG. 10B.

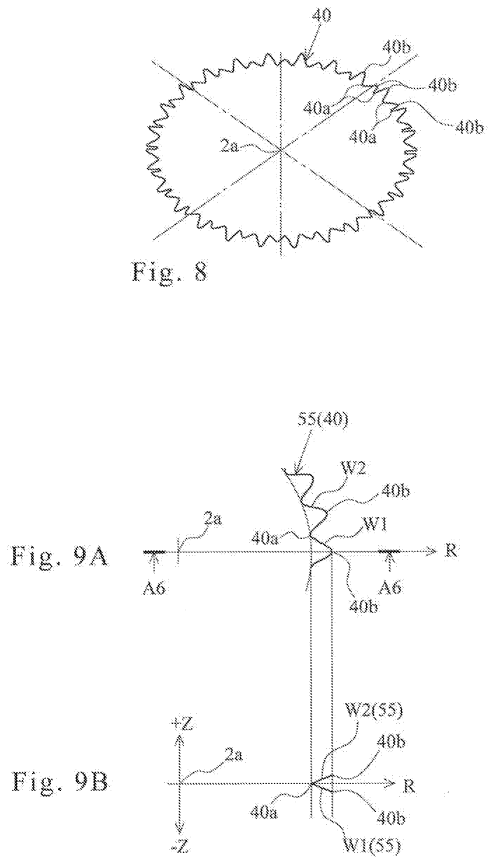

In the ball type speed reducer 1 according to this embodiment described above, as the input shaft 2 and the eccentric disk cam 4 rotate integrally by one turn, the shaking body 5 is shaken by a dimension “2e” twice the eccentric amount “e” of the eccentric disk cam 4, so that the balls 6 supported at the outer circumferential surface 5b of the shaking body 5 reciprocate inside the radial grooves 38 of the fixing member 7 by one trip. In this case, the output-side rotating body 8 (the first output-side rotating body 8A and the second output-side rotating body 8B) turns with respect to the fixing member 7 by one wave of the corrugated groove 40 because the balls 6 move in the radial direction of the first side face portion 32 and the second side face portion 41 inside the radial grooves 38 of the fixing member 7. Therefore, in the ball type speed reducer 1 according to this embodiment, since the number of waves of the corrugated groove 40 is set to “N,” and the number of radial grooves 38 is set to “(N+1)/3,” the output-side rotating body 8 rotates by a “1/N” turn oppositely to the input shaft 2 while the input shaft 2 rotates by one turn. Note that, as illustrated in FIGS. 5 and 8, in the ball type speed reducer 1 according to this embodiment, the number “N” of waves of the corrugated groove 40 of the output-side rotating body 8 is set to “50,” and the number “(N+1)/3” of radial grooves 38 of the fixing member 7 is set to “17” by way of example. Therefore, the ball type speed reducer 1 according to this embodiment decelerates rotation of the input shaft 2 by “ 1/50 (1/N)” and transmits the decelerated rotation to the output-side rotating body 8.

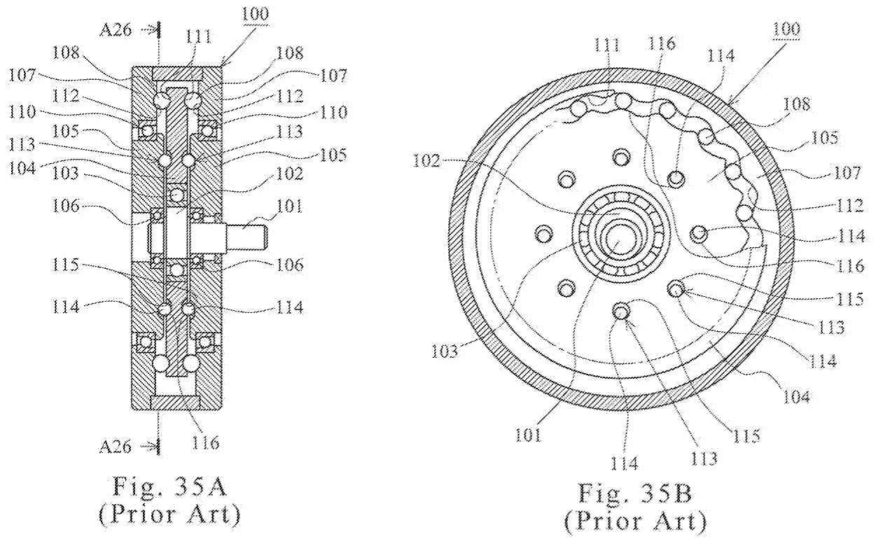

In the ball type speed reducer 1 according to this embodiment configured as described above, since the corrugated grooves 40 are formed only in two places: the first side face portion 32 of the first output-side rotating body 8A and the second side face portion 41 of the second output-side rotating body 8B, which face the shaking body 5 and the fixing member 7, it is possible to reduce the man-hours, compared to the ball type speed reducer 100 of the prior art (see FIGS. 35A and 35B) in which the corrugated grooves 111, 111, 112 and 112 are formed in four places. Further, in the ball type speed reducer 1 according to this embodiment, the shaking body 5 can be shaken independently from the fixing member 7 and the output-side rotating body 8 (the first output-side rotating body 8A and the second output-side rotating body 8B). Therefore, it is not necessary to provide a complicated mechanism for rotating the shaking body 5 and the output-side rotating body 8 integrally (for example, the eccentricity absorption mechanism 113, 113 of the ball type speed reducer 100 in the prior art shown in FIGS. 35A and 35B). Accordingly, it is possible to simplify the structure and reduce the man-hours.

In the ball type speed reducer 1 according to this embodiment, the ball 6 is positioned in a portion where the radial groove 38 and the corrugated groove 40 intersect. Therefore, compared to the ball type speed reducer 100 of the prior art in which the balls 108 simultaneously come into contact with the groove wall of the first corrugated groove 111 of the eccentric rotating plate 104 and the groove wall of the second corrugated groove 112 of the fixing member 107 (see FIGS. 35A and 35B), it is possible to facilitate machining of the radial groove 38 and the corrugated groove 40 and an assembly work for the shaking body 5, the fixing member 7, the output-side rotating body 8 (the first output-side rotating body 8A and the second output-side rotating body 8B), and the like.

Further, in the ball type speed reducer 1 according to this embodiment, compared to the case where the corrugated groove 40 is formed to have an equal groove depth at the first side face portion 32 of the first output-side rotating body 8A and the second side face portion 41 of the second output-side rotating body 8B, the groove depth at the top 40b of the corrugated groove 40 which contributes significantly to torque transmission is made deeper. Therefore, the amount of engagement between the top 40b of the corrugated groove 40 including its vicinity and the ball 6 is increased, thereby making it possible to increase a transmittable torque.

Further, in the ball type speed reducer 1 according to this embodiment, with respect to the number “N” of waves of the corrugated groove 40, the number of radial grooves 38 is set to “(N+1)/3” and the number of balls 6 housed in the radial groove 38 is set to “(N+1)/3.” Therefore, it is possible to reduce the weight by the reduced number of balls 6, compared to the case where the number of radial grooves 38 is set to “(N+1)” and the number of balls housed in the radial groove 38 is set to “(N+1).”

Further, in the ball type speed reducer 1 according to this embodiment, with respect to the number “N” of waves of the corrugated groove 40, the number of radial grooves 38 is set to “(N+1)/3” and the number of balls 6 housed in the radial groove 38 is set to “(N+1)/3.” Therefore, the size of the ball 6 can be set to be larger, and a large torque can be transmitted although the number of balls 6 is reduced.

Further, in the ball type speed reducer 1 according to this embodiment, since a plurality of the contact relief recesses 45 and 46 for reducing a contact resistance by reducing a contact area with the shaking body 5 are provided in the first output-side rotating body 8A and the second output-side rotating body 8B, it is possible to effectively transmit power. Note that, in the ball type speed reducer 1 according to this embodiment, since a viscous resistance of the grease applied between the first output-side rotating body 8A and the second output-side rotating body 8B and the shaking body 5 can be reduced by filling grease inside the contact relief recess 45 of the first output-side rotating body 8A and the contact relief recess 46 of the second output-side rotating body 8B, it is possible to reduce an energy loss caused by the viscous resistance of the grease and effectively transmit power.

Further, in the ball type speed reducer 1 according to this embodiment, if the number of waves of the corrugated groove 40 of the output-side rotating body 8 (the first output-side rotating body 8A and the second output-side rotating body 8B) is set to “N,” the reduction ratio becomes “1/N.” Therefore, it is possible to increase the reduction ratio relative to the ball type speed reducer 100 of the prior art illustrated in FIG. 35.

### First Modification of First Embodiment

In the ball type speed reducer 1 according to this embodiment, the number “N” of waves of the corrugated groove 40 of the output-side rotating body 8 (the first output-side rotating body 8A and the second output-side rotating body 8B) is set to “50,” the number “(N+1)/3” of radial grooves 38 of the fixing member 7 is set to “17,” and the number of balls 5 is set to “17” by way of example. However, without limiting thereto, the number “N” of waves of the corrugated groove 40, the number “(N+1)/3” of radial grooves 38, and the number of balls 6 may be determined to change the reduction ratio on the conditions that the number “N” of waves of the corrugated groove 40 is set to an even number (a multiple of “2”) and the number “(N+1)/3” of radial grooves 38 is set to a natural number. Note that the number of balls 6 may be smaller than the number of grooves of the radial groove 40 as long as smooth rotation transmission of the ball type speed reducer 1 is not impaired.

### Second Modification of First Embodiment

Further, in the ball type speed reducer 1 according to this embodiment, the number “N” of waves of the corrugated groove 40 of the output-side rotating body 8 (the first output-side rotating body 8A and the second output-side rotating body 8B) is set to “50,” the number “(N+1)/3” of radial grooves 38 of the fixing member 7 is set to “17,” and the number of balls 6 is set to “17” by way of example. However, without limiting thereto, the number “N” of waves of the corrugated groove 40, the number “(N−1)/3” of radial grooves 38, and the number of balls 6 may be determined to change the reduction ratio on the conditions that the number “N” of waves of the corrugated groove 40 is set to an even number (a multiple of “2”) and the number “(N−1)/3” of radial grooves 38 is set to a natural number. For example, their numbers may be determined such that the number “N” of waves of the corrugated groove 40 of the output-side rotating body 8 is set to “46,” the number “(N−1)/3” of radial grooves 38 of the fixing member 7 is set to “15,” and the number “(N−1)/3” of balls 6 is set to “15.” In the ball type speed reducer 1 according to the second modification, the output-side rotating body 8 rotates by “1/N” for one rotation of the input shaft 2 in the same rotation direction as the input shaft 2. Note that the number of balls 6 may be smaller than the number of radial grooves 38 as long as smooth rotation transmission of the ball type speed reducer 1 is not impaired.

### Second Embodiment

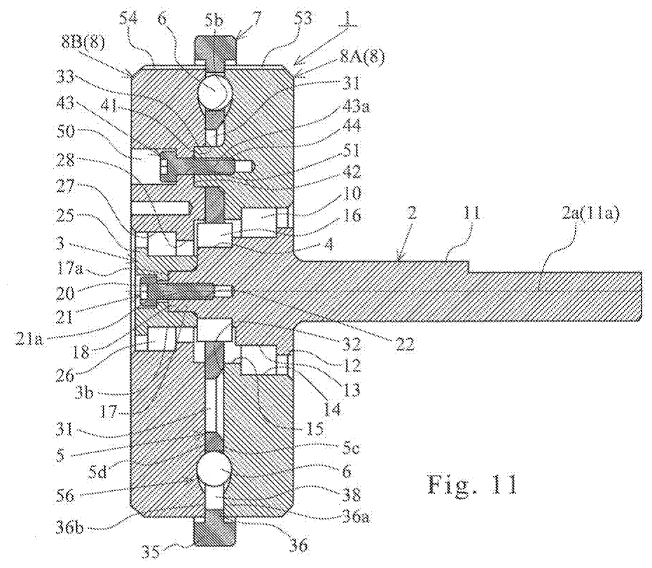

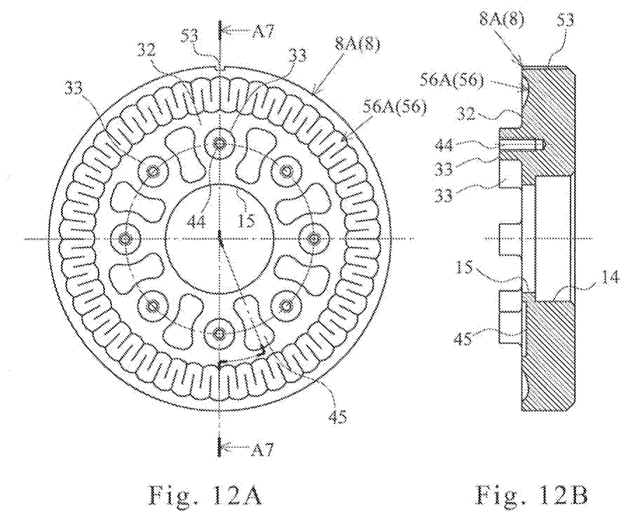

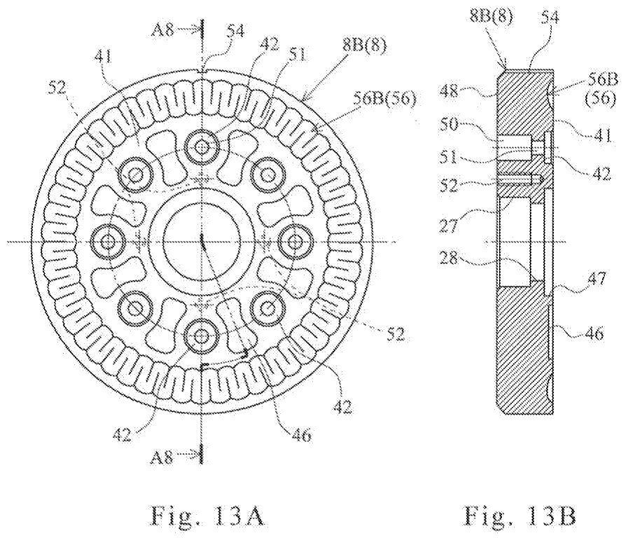

FIGS. 11-13B are explanatory diagrams of the ball type speed reducer 1 according to a second embodiment of the invention. Note that FIG. 11 is a longitudinal cross-sectional view illustrating the ball type speed reducer 1 according to the second embodiment of the invention. FIG. 12A is a front view illustrating the first output-side rotating body 8A, and FIG. 12B is a cross-sectional view taken along the line A7-A7 of FIG. 12A to illustrate the first output-side rotating body 8A. FIG. 13A is a front view illustrating the second output-side rotating body 8B, and FIG. 13B is a cross-sectional view taken along the line A8-A8 of FIG. 13A to illustrate the second output-side rotating body 8B.

As shown in FIGS. 11-13B, in the ball type speed reducer 1 according to this embodiment, the shape of corrugated grooves 56 of the first output-side rotating body 8A and the second output-side rotating body 8B are different from the shape of the corrugated grooves 40 of the first output-side rotating body 8A and the second output-side rotating body 8B in the ball type speed reducer 1 according to the first embodiment, but the other configuration is the same as the ball type speed reducer 1 according to the first embodiment. Therefore, in the description of the ball type speed reducer 1 according to this embodiment, like reference numerals denote like elements as in the ball type speed reducer 1 of the first embodiment, and they will not be repeatedly described.

In the ball type speed reducer 1 according to this embodiment, the corrugated groove 56 is formed across the first side face portion 32 of the first output-side rotating body 8A and the second side face portion 41 of the second output-side rotating body 8B. In addition, a first corrugated groove portion 56A on the first output-side rotating body 8A side and a second corrugated groove portion 56B on the second output-side rotating body 8B side in the corrugated grooves 56 have the same planar shape and same groove depth, and has a shape such that one is mirrored to the other. Further, the first corrugated groove portion 56A on the first output-side rotating body 8A side and the second corrugated groove portion 56B on the second output-side rotating body 8B side are formed to have a constant groove depth, unlike the corrugated grooves 40 of the ball type speed reducer 1 according to the first embodiment. Note that, in the ball type speed reducer 1 according to this embodiment, as in the ball type speed reducer 1 according to the first embodiment, the number of waves of the corrugated groove 56 (the numbers of waves of the first corrugated groove portion 56A of the first output-side rotating body 8A and the second corrugated groove portion 56B of the second output-side rotating body 8B) is set to “50,” the number “(N+1)/3” of radial grooves 38 of the fixing member 7 is set to “17,” and the number of balls 6 is set to “17” by way of example. However, unlike the ball type speed reducer 1 according to the first embodiment, the ball type speed reducer 1 according to this embodiment is not limited to an even number “N” of waves of the corrugated groove 56, and the number “N” of waves of the corrugated groove 56 may be set to an odd number, and the number of radial grooves 38 may be set to “N+1,” “N−1,” “(N+1)/2,” or “(N−1)/2.”

In the ball type speed reducer 1 according to this embodiment configured as described above, since the corrugated grooves 56 are formed only in two places: the first side face portion 32 of the first output-side rotating body 8A and the second side face portion of the second output-side rotating body 8B (the first corrugated groove portion 56A of the corrugated groove 56 is formed in the first side face portion 32 of the first output-side rotating body 8A, and the second corrugated groove portion 56B of the corrugated groove 56 is formed in the second side face portion 41 of the second output-side rotating body 8B), it is possible to reduce the man-hours, compared to the ball type speed reducer 100 of the prior art (see FIGS. 35A and 35B) in which the corrugated grooves 111,111, 112, and 112 are formed in four places. Further, in the ball type speed reducer 1 according to this embodiment, the shaking body 5 can be shaken independently from the fixing member 7 and the output-side rotating body 8 (the first output-side rotating body 8A and the second output-side rotating body 8B). Therefore, it is not necessary to provide a complicated mechanism for turning the shaking body 5 and the output-side rotating body 8 integrally (for example, the eccentricity absorption mechanism 113, 113 of the ball type speed reducer 100 in the prior art shown in FIGS. 35A and 35B). Accordingly, it is possible to simplify the structure and reduce the man-hours.

Further, in the ball type speed reducer 1 according to this embodiment, the ball 6 is positioned in a portion where the radial groove 38 and the corrugated groove 56 intersect. Therefore, compared to the ball type speed reducer 100 of the prior art in which the balls 108 simultaneously come into contact with the groove wall of the first corrugated groove 111 of the eccentric rotating plate 104 and the groove wall of the second corrugated groove 112 of the fixing member 107 (see FIGS. 35A and 35B), it is possible to facilitate machining of the radial groove 38 and the corrugated groove 56 and an assembly work for the shaking body 5, the fixing member 7, the output-side rotating body 8 (the first output-side rotating body 8A and the second output-side rotating body 8B), and the like.

### Third Embodiment

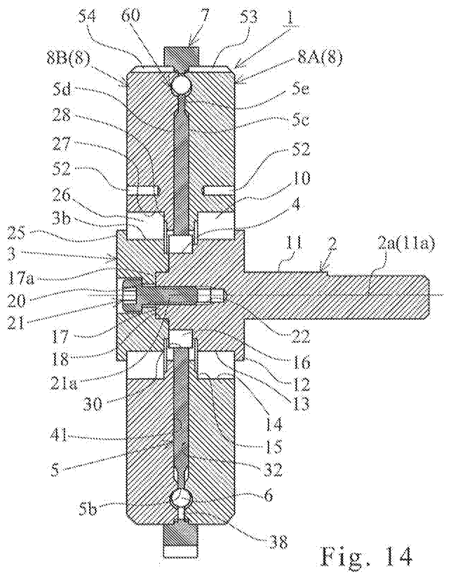

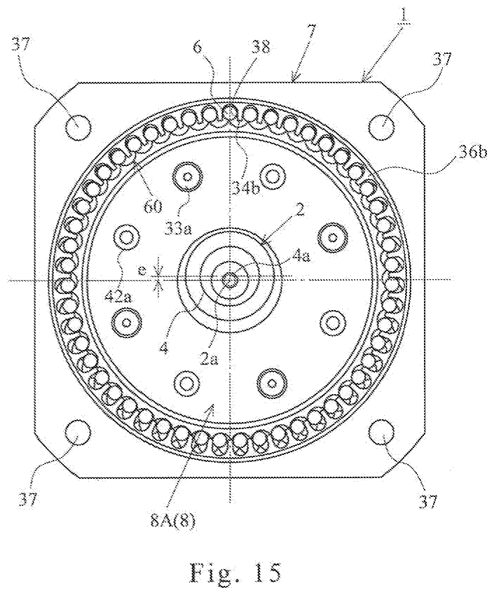

FIG. 14 is a longitudinal cross-sectional view illustrating a ball type speed reducer 1 according to a third embodiment of the invention. As illustrated in FIG. 14, the ball type speed reducer 1 according to this embodiment includes an input shaft (input-side rotating body) 2, a cap (input-side rotating body) 3, an eccentric disk cam 4, a shaking body 5, a plurality of balls (steel balls) 6, a fixing member 7, an output-side rotating body 8 (a first output-side rotating body 8A and a second output-side rotating body 8B), and the like. FIG. 15 is a front view illustrating the ball type speed reducer 1 in which the cap 3, the second output-side rotating body 8B, the shaking body 5, and the like are removed.

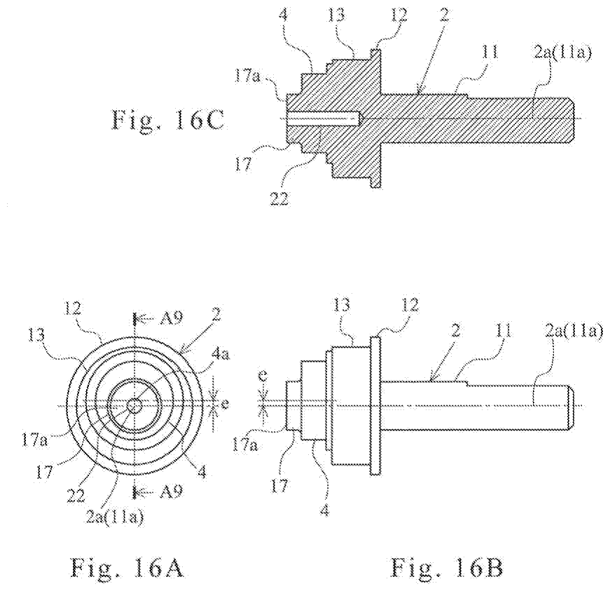

As illustrated in FIGS. 14-16C, the input shaft 2 turnably supports the first output-side rotating body 8A by interposing a first bearing 10, so that the input shaft 2 is rotationally driven by a motor or the like (not shown). The input shaft 2 is formed such that a flange-like portion 12 having a diameter larger than that of a shaft body portion 11 is adjacent to the shaft body portion 11. A bearing support portion 13 is formed adjacent to the flange-like portion 12. The first bearing 10 is attached to the bearing support portion 13 to hold the first bearing 10 between an inner protrusion 15 of a bearing hole 14 of the first output-side rotating body 8A and the flange-like portion 12. Further, the input shaft 2 has the eccentric disk cam 4 formed closer to a shaft tip side than the bearing support portion 13 and in the vicinity of the bearing support portion 13. This eccentric disk cam 4 is a decentered shaft portion having a center 4a decentered from a rotation center 2a of the input shaft 2 (a rotation center 11a of the shaft body portion 11) by an eccentric amount “e,” and is eccentrically rotated integrally with the input shaft 2 by virtue of rotation of the rotation center 2a of the input shaft 2. In addition, the shaking body 5 is relatively turnably installed in the outer circumference side of the eccentric disk cam 4 by interposing a second bearing 16. Further, the input shaft 2 has a tip shaft portion 17 formed to install the cap 3. The tip shaft portion 17 has a rotation center concentric with the rotation center 2a of the shaft body portion 2 and fitted in a shaft hole 18 of the cap 3 and has a leading end face 17a abutting on a stopper protrusion 20 protruding into the shaft hole 18 of the cap 3. Further, in the tip shaft portion 17 of the input shaft 2, a screw hole (female screw) 22 to be screwed with a screw shaft portion 21a of a bolt 21 for fixing the cap 3 is formed.

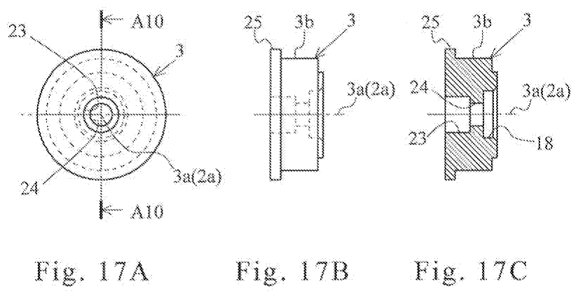

As shown in FIGS. 14 and 17A-17C, the cap 3 is fixed to the tip shaft portion 17 of the input shaft 2 with the bolt 21, constitutes an input-side rotating body together with the input shaft 2, and has a rotation center 3a coinciding with the rotation center 2a of the input shaft 2. The cap 3 has the shaft hole 18 opened at one end side (right end side in FIG. 17C) along a rotation center 3a, a bolt head housing hole 23 opened at the other end side along the rotation center 3a (left end side in FIG. 17C), and a bolt shaft insertion hole 24 through which the bolt head housing hole 23 and the shaft hole 18 are communicated with each other. Further, the cap 3 has a ring-shaped bearing stopper 25 on the left end side of a cylindrical outer circumferential surface 3b. A side face of a third bearing 26 attached to the outer circumferential surface 3b abuts on the bearing stopper 25, so that the third bearing 26 is held between an inner protrusion 28 in the bearing hole 27 of the second output-side rotating body 8B and the bearing stopper 25. Note that, in the cap 3, the rotation center of the shaft hole 18 and the rotation center of the outer circumferential surface 3b are concentric with the rotation center 3a of the cap 3. Further, the cap 3 is formed to have an outer diameter of the outer circumferential surface 3b that is the same as the outer diameter of the bearing support portion 13 of the input shaft 2. In addition, the third bearing 26 attached to the outer circumferential surface 3b of the cap 3 as used is the same as the first bearing 10 attached to the bearing support portion 13 of the input shaft 2.

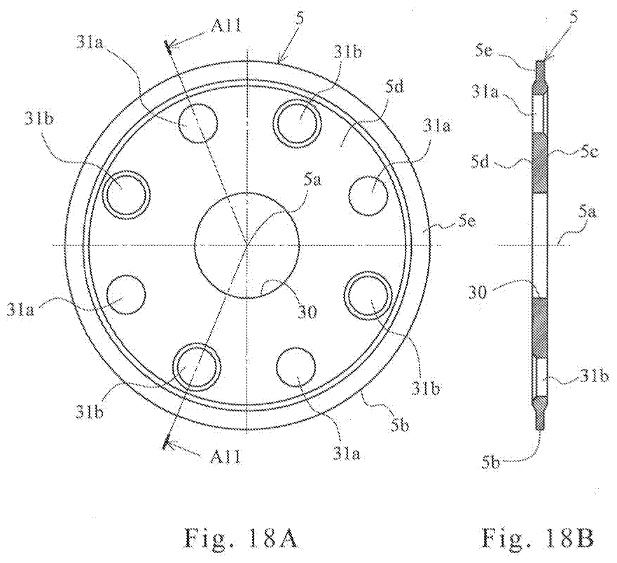

As shown in FIGS. 14 and 18A-18B, the shaking body 5 is formed in a disk shape so as to be shaken by the eccentric disk cam 4, has a central bearing hole 30 fitted to the outer circumferential surface of the second bearing 16, and is supported by the second bearing 16 so as to be able to turn relative to the eccentric disk cam 4. In the shaking body 5, a center 5a is formed so as to be concentric with the center 4a of the eccentric disk cam 4, and an outer circumferential surface 5b is a cylindrical surface concentric with the center 4a of the eccentric disk cam 4. The plurality of balls 6 are rotatably supported at the outer circumferential surface 5b. Further, in the shaking body 5, four first through holes 31a are formed at equal intervals along the circumferential direction on an outer side of the radial direction of the bearing hole 30. The first through hole 31a of the shaking body 5 is engaged with a coupling protrusion 33a formed on a first side face portion 32 of the first output-side rotating body 8A with a gap therebetween, and is formed to have a size such that the first through hole 31a does not contact the coupling protrusion 33a even when the shaking body 5 is shaken by the eccentric disk cam 4. Further, in the shaking body 5, four second through holes 31b are formed at equal intervals along the circumferential direction on an outer side of the radial direction of the bearing hole 30. The second through hole 31b of the shaking body 5 is engaged with a coupling protrusion 33b formed on a second side face portion 41 of the second output-side rotating body 8B with a gap therebetween, and is formed to have a size such that the second through hole 31b does not contact the coupling protrusion 33b even when the shaking body 5 is shaken by the eccentric disk cam 4. In addition, the first through holes 31a and the second through holes 31b are alternately arranged at equal intervals.

As shown in FIGS. 14, 15, and 19A-19B, the fixing member 7 has a substantially square shape on the front side, and a shaking body housing hole 34 is formed in its central portion. The fixing member 7 has a fixing frame portion 35 formed along the outer edge, and a radial groove forming disk portion 36 formed on the inner side of the radial direction of the fixing frame portion 35. In addition, in the fixing member 7, bolt holes 37 are formed at four corners of the fixing frame portion 35. Fixing bolts (not shown) are inserted into the bolt holes 37 in the four places, so that the fixing member 7 is fixed to a fixation target member (not shown) (for example, a machine frame or a robot arm) by the fixing bolts. The fixing member 7 is fixed to the fixation target member such that a center 34a of the shaking body housing hole 34 is concentric with the rotation center 2a of the input shaft 2. In addition, the shaking body 5 is housed in the shaking body housing hole 34 of the fixing member 7 so as to be able to be shaken. Further, in the fixing member 7, a plurality of radial grooves 38 extending along the radial direction from an inner circumferential surface 34b of the shaking body housing hole 34 are formed along the circumferential direction at equal intervals (in “(N+1)” places when the number of waves of a corrugated groove 60 is set to “N”). The radial groove 38 is an open end whose radial inner end allows the ball 6 to enter and exit, has a groove width slightly larger than the diameter of the ball 6, and has a groove length (length in the radial direction) which is a length taking into consideration the amount of shaking of the shaking body 5 (the eccentric amount e of the eccentric disk cam 4), so that the ball 6 supported at the outer circumferential surface 5b of the shaking body 5 is slidably moved along the radial direction. Further, in the fixing member 7, a plate thickness of the radial groove forming disk portion 36 is formed smaller than the diameter of the ball 6, so that the ball 6 is uniformly protruded on both sides of the radial groove forming disk portion 36 and the ball 6 in the radial groove 38 is rollably engaged with the corrugated groove 60 formed in the output-side rotating body 8 when the center of the ball 6 engaged with the radial groove 38 is aligned with the center position in the thickness direction of the radial groove forming disk portion 36. Such radial grooves 30 of the fixing member 7 can roll the balls 6 in the radial direction depending on a shake amount of the shaking body 5 as the eccentric disk cam 4 rotates by one turn, and the shaking body 5 is shaken by one stroke. Note that, in this embodiment, the plate thickness of the radial groove forming disk portion 36 of the fixing member 7 is the same as the plate thickness of a ball support portion 5e placed on the radial outward end side of the shaking body 5.

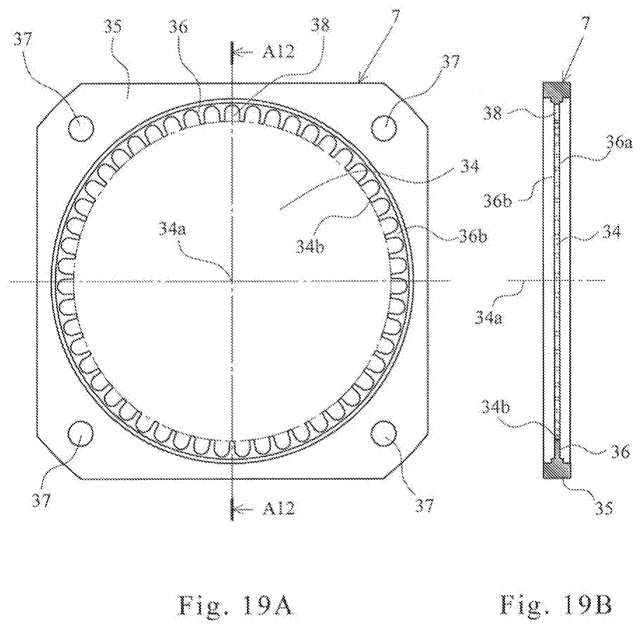

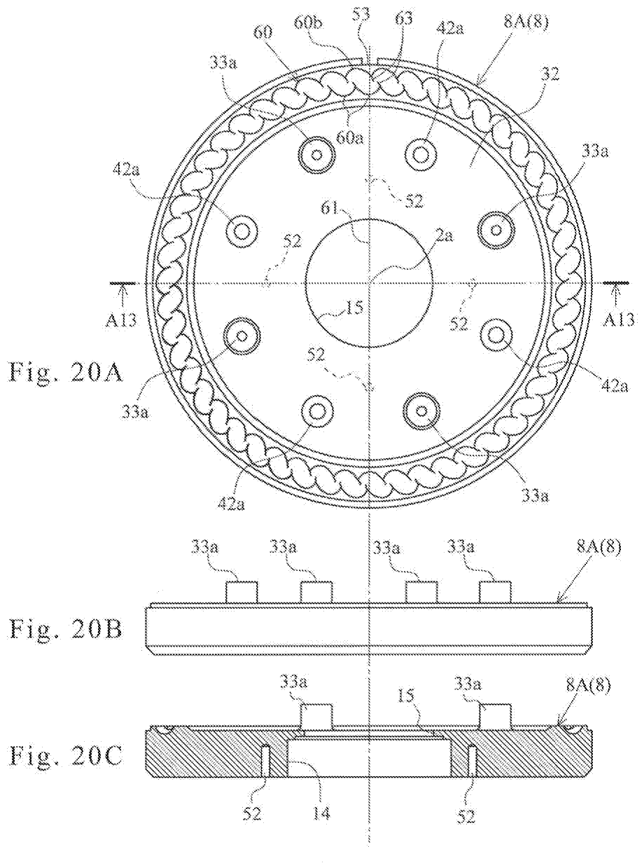

As shown in FIGS. 14 and 20A-20C, the first output-side rotating body 8A has the first side face portion 32 placed to face one side face 5c of both side faces 5c and 5d of the shaking body 5, and one side face 36a of both side faces 36a and 36b of the radial groove forming disk portion 36 of the fixing member 7. Further, in the first output-side rotating body 8A, the bearing hole 14 for housing the first bearing 10 attached to the input shaft 2 is formed, so that the side face of the outer race of the first bearing 10 abuts on the inner protrusion 15 formed at the end of the bearing hole 14. In the first side face portion 32 of the first output-side rotating body 8A, a plurality of coupling protrusions 33a for coupling and fixing the second output-side rotating body 8B are formed at equal intervals (in four places) in the circumferential direction. The coupling protrusion 33a is inserted into the through hole 31a of the shaking body 5 so as to be fitted in a coupling protrusion housing recess 42b formed on a second side face portion 41 of the second output-side rotating body 8B. Further, in the first side face portion 32 of the first output-side rotating body 8A, a plurality of coupling protrusion housing recesses 42a for coupling and fixing the second output-side rotating body 8B are formed at equal intervals (in four places) in the circumferential direction. A coupling protrusion 33b is formed extending through the through hole 31b of the shaking body 5 on the second side face portion 41 of the second output-side rotating body 8B so as to be fitted in the coupling protrusion housing recess 42a. Further, in the first side face portion 32 of the first output-side rotating body 8A, the corrugated groove 60 is formed on the outer side of the radial direction of the coupling protrusion 33a and the coupling protrusion housing recess 42a. Further, on the back face side of the first output-side rotating body 8A (face side placed opposite to the first side face portion 32), screw holes 52 for fixing a fixation target member are formed in four places at equal intervals along the circumferential direction closer to the inner side in the radial direction than the coupling protrusion 33a. Further, in the first output-side rotating body 8A, a positioning groove 53 for positioning and fixing the second output-side rotating body 8B with high accuracy is formed at one position on the radial outer end. Note that the structures of the coupling protrusion 33a and the coupling protrusion housing recess 42a, and the structure for fixing the second output-side rotating body 8B to the first output-side rotating body 8A with bolts (not shown) are the same as the structures of the ball type speed reducer 1 shown in FIGS. 1 and 11.

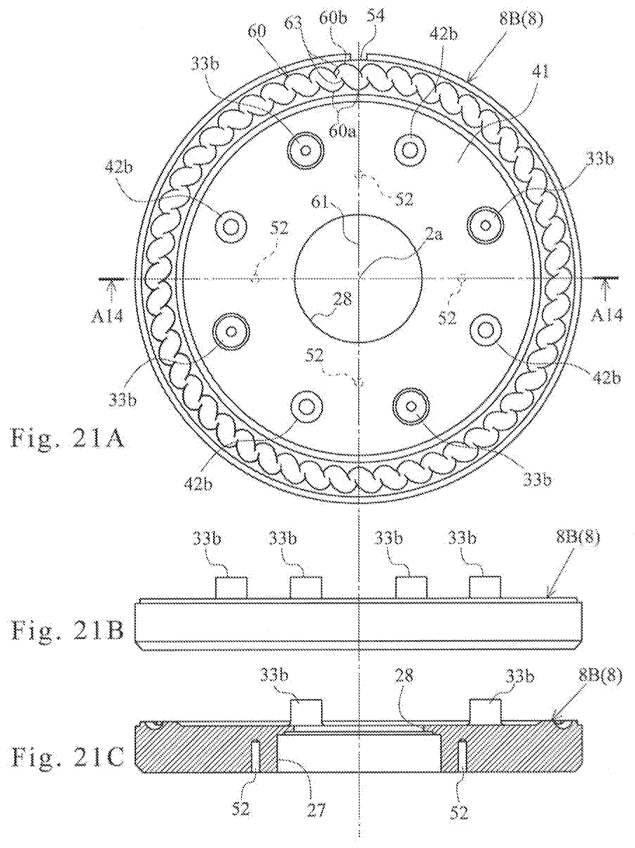

As shown in FIGS. 14 and 21A-21C, the second output-side rotating body 8B has the second side face portion 41 placed to face the other side face 5d of both the side faces 5c and 5d of the shaking body 5, and the other side face 36b of both the side faces 36a and 36b of the radial groove forming disk portion 36 of the fixing member 7. In the second side face portion 41 of the second output-side rotating body 8B, a plurality of coupling protrusion housing recesses 42b in which the coupling protrusions 33 are fitted are formed as many as the coupling protrusions 33a at positions facing the respective coupling protrusions 33a of the first output-side rotating body 8A. Further, in the second side face portion 41 of the second output-side rotating body 8B, a plurality of coupling protrusions 33b fitted to the coupling protrusion housing recesses 42a are formed as many as the coupling protrusion housing recesses 42a at positions facing the respective coupling protrusion housing recesses 42a of the first output-side rotating body 8A. Further, in the second output-side rotating body 8B, the bearing hole 27 for housing the third bearing 26 attached to the cap 3 is formed, so that the side face of the outer race of the third bearing 26 abuts on the inner protrusion 28 formed at the end of the bearing hole 27. Further, in the second side face portion 41 of the second output-side rotating body 8B, the corrugated groove 60 is formed on the outer side of the radial direction of the coupling protrusion 33b and the coupling protrusion housing recess 42b. Further, on the back face side of the second output-side rotating body 8B (face side placed opposite to the second side face portion 41), screw holes 52 for fixing a fixation target member are formed in four places at equal intervals along the circumferential direction closer to the inner side in the radial direction than the coupling protrusion 33b. Further, in the second output-side rotating body 8B, a positioning groove 54 for positioning and fixing the first output-side rotating body 8A with high accuracy is formed in the position (one position of the radial outer end) corresponding to the positioning groove 53 of the first output-side rotating body 8A. Such a second output-side rotating body 8B has a shape as the second side face portion 41 is viewed in plan (a shape shown in FIG. 21A) that is the same as the shape as the first output-side rotating body 8A is viewed in plan (FIG. 20A). Further, the second output-side rotating body 8B has the same longitudinal sectional shape (the sectional shape shown in FIG. 20C) as the longitudinal sectional shape of the first output-side rotating body 8A (the sectional shape shown in FIG. 21C). Note that the structures of the coupling protrusion 33b and the coupling protrusion housing recess 42b, and the structure for fixing the second output-side rotating body 8B to the first output-side rotating body 8A with bolts (not shown) are the same as the structures of the ball type speed reducer 1 shown in FIGS. 1 and 11.

As shown in FIGS. 14, 20A-20C, and 21A-21C, the corrugated groove 60 is formed across the first side face portion 32 of the first output-side rotating body 8A and the second side face portion 41 of the second output-side rotating body 8B, and an even number (“N”=50) of waves are continuously formed annularly around the rotation center 2a of the input shaft 2, so that the corrugated groove 60 is rollably engaged with the balls 6 housed in the radial groove 38 of the fixing member in “(N+1)” places (51 places). When the corrugated groove 60 is formed to have waves in which a portion located at a radial inner end of a wave is referred to as a bottom 60a and a portion located at a radial outer end of the wave is referred to as a top 60b, the bottom 60a and the top 60b are formed equally across the first side face portion 32 of the first output-side rotating body 8A and the second side face portion 41 of the second output-side rotating body 8B, so that the bottom 60a and the top 60b in the first side face portion 32 and the second side face portion 41 have the same groove depth. Further, as shown in FIG. 20A, the corrugated groove 60 is formed such that in regard to the first side face portion 32 of the first output-side rotating body 8A, the groove depth gradually decreases from the bottom 60a on a center line 61 toward the top 60b on the right and then gradually increases, and the groove depth gradually increases from the top 60b toward the bottom 60a on the right and then gradually decreases. Further, as shown in FIG. 21A, the corrugated groove 60 is formed such that in regard to the second side face portion 41 of the second output-side rotating body 8B facing the first side face portion 32 of the first output-side rotating body 8A, the groove depth gradually increases from the bottom 60a on the center line 61 toward the top 60b on the left and then gradually decreases, and the groove depth gradually decreases from the top 60b toward the bottom 60a on the left and then gradually increases. That is, the corrugated groove 60 formed across the first side face portion 32 of the first output-side rotating body 8A and the second side face portion 41 of the second output-side rotating body 8B spirally guides the ball 6 along the circumferential direction of the first output-side rotating body 8A and the second output-side rotating body 8B. Therefore, when moving along the radial direction in the radial groove 38, the ball 6, which is engaged with the corrugated groove 60 formed across the first output-side rotating body 8A and the second output-side rotating body 8B and also the radial groove 38 of the fixing member 7, is also moved in the direction along the rotation center 2a of the input shaft 2 by following the three-dimensionally formed corrugated groove 60. Note that, although the corrugated groove 60 is formed across the first side face portion 32 of the first output-side rotating body 8A and the second side face portion 41 of the second output-side rotating body 8B as described above, the corrugated groove 60 is shaped with high precision without any deviation between the corrugated groove 60 on the first output-side rotating body 8A side and the corrugated groove 60 on the second output-side rotating body 8B side. This is because when the first output-side rotating body 8A and the second output-side rotating body 8B are fixed, the first output-side rotating body 8A and the second output-side rotating body 8B are in a state of being positioned with high accuracy by aligning a positioning groove 53 of the first output-side rotating body 8A with a positioning groove 54 of the second output-side rotating body 8B (see FIGS. 14, 20A-20C, and 21A-21C). Further, the corrugated groove 60 has only to guide the ball 6 in a right-handed spiral or a left-handed spiral along the circumferential direction of the first output-side rotating body 8A and the second output-side rotating body 8B.

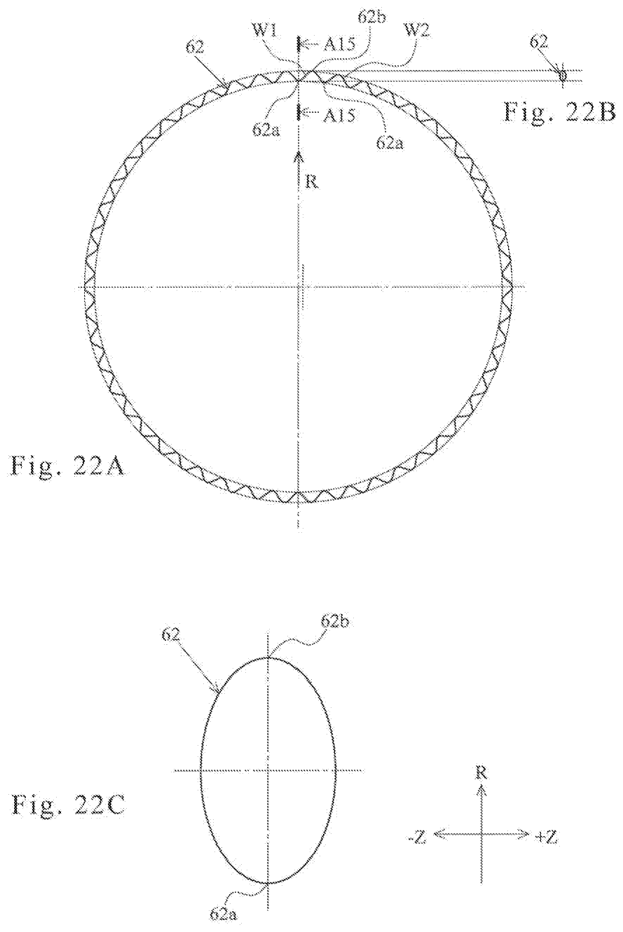

FIGS. 22A-22C illustrating a rolling trajectory 62 of the ball 6 when the ball 6 is rolled in the corrugated groove 60. Note that FIG. 22A is a plan view illustrating the rolling trajectory 62 of the ball 6 (rolling trajectory 62 projected on a virtual plane perpendicular to the rotation center 2a of the input shaft 2). Further, FIG. 22B is a diagram illustrating adjacent waves W1 and W2 in the rolling trajectory 62 projected on a virtual cross section taken along the line A15-A15 of FIG. 22A. Further, FIG. 22C is an enlarged view illustrating the rolling trajectory of the ball of FIG. 22B. In addition, the rolling trajectory 62 of the ball 6 shown in FIGS. 22A-22C indicates a groove shape of the corrugated groove 60. Further, in FIGS. 22A-22C, R represents the radial direction, and Z represents the direction along the rotation center 2a of the input shaft 2.

As shown in FIGS. 22A-22C, the rolling trajectory 62 of the ball 6 moving along the corrugated groove 60 traces an elliptical shape whose major axis is the R direction. The center of the ball 6 is located in the middle between the first side face portion 32 and the second side face portion 41 at each of the bottom 60a and the top 60b of the corrugated groove 60 (a bottom 62a and a top 62b of the rolling trajectory 62). The amount of movement in the +Z direction is gradually increased from the bottom 62a of the first wave W1 toward the top 62b of the first wave W1 and then gradually decreased, and the amount of movement in the −Z direction is gradually increased from the top 62b of the first wave W1 toward the bottom 62a of the adjacent second wave W2 and then gradually decreased. In addition, in the rolling trajectory 62 of the ball 6, the amount of movement in the +Z direction is the same as the amount of movement in the −Z direction. Such a rolling trajectory 62 of the ball 6 is shaped by the corrugated groove 60 formed across the first output-side rotating body 8A and the second output-side rotating body 8B.

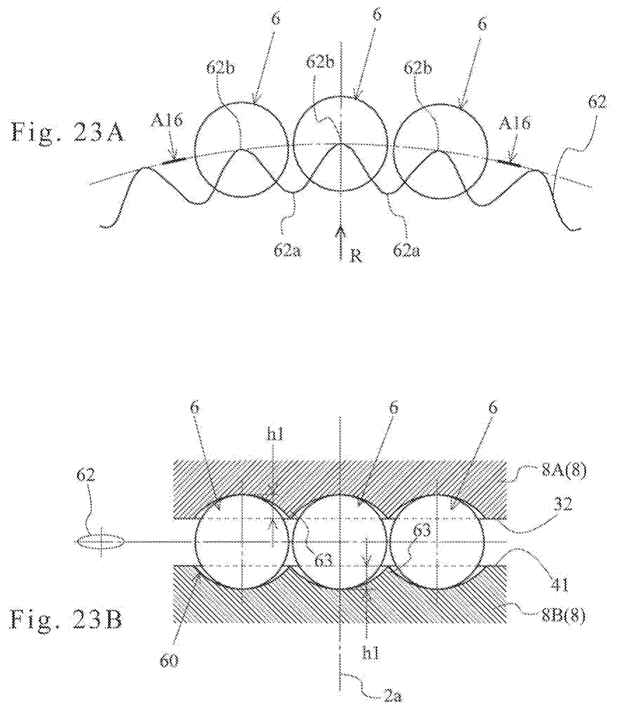

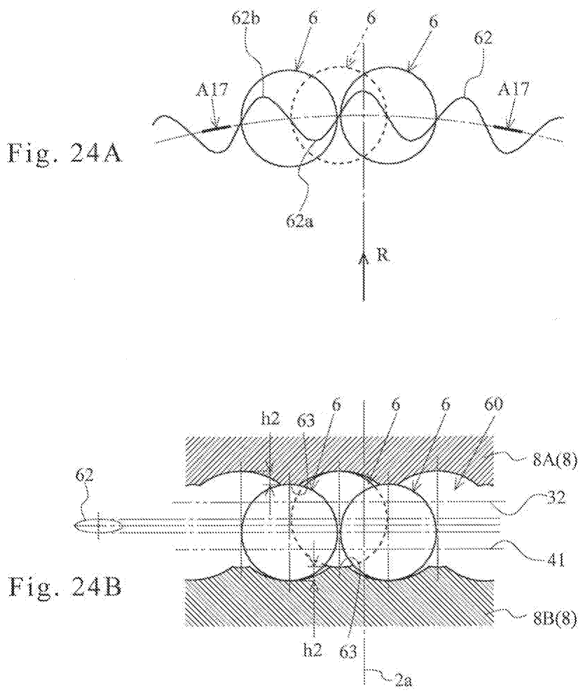

FIGS. 23A-24B are diagrams illustrating features of the corrugated groove 60 of the ball type speed reducer 1 according to this embodiment. Note that FIG. 23A illustrates an arrangement in which balls 6 are located at the top 62b in the rolling trajectory 62 of the ball 6 (a partial plan view illustrating the rolling trajectory 62), and FIG. 23B is a cylindrical cross-sectional view taken at the position corresponding to the line A16-A16 of FIG. 23A to illustrate the ball type speed reducer 1. Further, FIG. 24A illustrates an arrangement in which balls 6 are located at a middle position between the top 62b and the bottom 62a in the rolling trajectory 62 of the ball 6 (a partial plan view illustrating the rolling trajectory 62), and FIG. 24B is a cylindrical cross-sectional view taken at the position corresponding to the line A17-A17 of FIG. 24A to illustrate the ball type speed reducer 1.

As shown in FIGS. 23A and 23B, in the ball type speed reducer 1 according to this embodiment, the top 62b of the rolling trajectory 62 of the ball 6 is positioned at one end of the major axis of the elliptical rolling trajectory 62 of FIG. 22C. The corrugated groove 60 has the same groove depth at each of the first output-side rotating body 8A and the second output-side rotating body 8B (the groove depth from the first side face portion 32 and the groove depth from the second side face portion 41 are the same). At each of the first output-side rotating body 8A and the second output-side rotating body 8B, a ridge portion 63 having the same ridge height h1 is formed between the adjacent balls 6, 6. Note that, in the ball type speed reducer 1 according to this embodiment, the cylindrical cross-sectional view at the bottom 62a of the rolling trajectory 62 of the ball 6 is the same as FIG. 23B.

Further, as shown in FIGS. 24A and 24B, in the ball type speed reducer 1 according to this embodiment, the middle position between the top 62b and the bottom 62a of the rolling trajectory 62 of the ball 6 corresponds to the position of the minor axis of the elliptical rolling trajectory 62 of FIG. 22C. The corrugated groove 60 has the same groove depth at each of the first output-side rotating body 8A and the second output-side rotating body 8B (the groove depth from the first side face portion 32 and the groove depth from the second side face portion 41 are the same). At each of the first output-side rotating body 8A and the second output-side rotating body 8B, a ridge portion 63 having the same ridge height h2 is formed between the adjacent balls 6, 6.

As shown in FIGS. 23A-24B, in the ball type speed reducer 1 according to this embodiment, since the corrugated groove 60 engaged with the ball 6 is formed in a spiral shape in the first output-side rotating body 8A and the second output-side rotating body 8B (see FIGS. 22A-22C), the ridge portion 63 having the sufficient ridge height h1 or h2 that can prevent ratcheting is formed between the adjacent balls 6, 6 at any of the position of the bottom 60a of the corrugated groove 60, the middle position between the bottom 60a and the top 60b of the corrugated groove 60, and the position of the top 60b of the corrugated groove 60.

In the ball type speed reducer 1 according to this embodiment configured as described above, since the corrugated grooves 60 are formed only in two places: the first side face portion 32 of the first output-side rotating body 8A and the second side face portion 41 of the second output-side rotating body 8B, it is possible to reduce the man-hours, compared to the ball type speed reducer 100 of the prior art (see FIGS. 35A and 35B) in which the corrugated grooves 111, 111, 112, and 112 are formed in four places. Further, in the ball type speed reducer 1 according to this embodiment, the shaking body 5 can be shaken independently from the fixing member 7 and the output-side rotating body 8 (the first output-side rotating body 8A and the second output-side rotating body 8B). Therefore, it is not necessary to provide a complicated mechanism for turning the shaking body 5 and the output-side rotating body 8 integrally (for example, the eccentricity absorption mechanism 113, 113 of the ball type speed reducer 100 in the prior art shown in FIGS. 35A and 35B). Accordingly, it is possible to simplify the structure and reduce the man-hours.

Further, in the ball type speed reducer 1 according to this embodiment, the ball 6 is positioned in a portion where the radial groove 38 and the corrugated groove 60 intersect. Therefore, compared to the ball type speed reducer 100 of the prior art in which the balls 108 simultaneously come into contact with the groove wall of the first corrugated groove 111 of the eccentric rotating plate 104 and the groove wall of the second corrugated groove 112 of the fixing member 107 (see FIGS. 35A and 35B), it is possible to facilitate machining of the radial groove 38 and the corrugated groove 60 and an assembly work for the shaking body 5, the fixing member 7, the output-side rotating body 8 (the first output-side rotating body 8A and the second output-side rotating body 8B), and the like.

Further, as shown in FIGS. 14, 20A-20C, and 21A-21C, in the ball type speed reducer 1 according to the this embodiment, the first output-side rotating body 8A and the second output-side rotating body 8B have the same shape, so that their parts (the first output-side rotating body 8A, the second output-side rotating body 8B, the first bearing 10, and the third bearing 26) can be made common, thereby making it possible to reduce the parts cost. The technical concept of the ball type speed reducer 1 according to this embodiment can be applied to the ball type speed reducer 1 according to the first embodiment and the ball type speed reducer 1 according to the second embodiment. That is, in the ball type speed reducer 1 according to the first embodiment, the first output-side rotating body 8A and the second output-side rotating body 8B have the same shape, so that their parts (the first output-side rotating body 8A, the second output-side rotating body 8B, the first bearing 10, and the third bearing 26) are made common, thereby making it possible to reduce the parts cost. Note that, in this case, for example, by rotating the position of the corrugated groove 40 of the first output-side rotating body 8A according to the first embodiment shown in FIGS. 6A and 6B by an angle of ½ wave with respect to the positioning groove 54, the first output-side rotating body 8A and the second output-side rotating body 8B can have the same shape. Further, in the ball type speed reducer 1 according to the second embodiment, the first output-side rotating body 8A and the second output-side rotating body 8B have the same shape, so that their parts (the first output-side rotating body 8A, the second output-side rotating body 8B, the first bearing 10, and the third bearing 26) are made common, thereby making it possible to reduce the parts cost.

### First Modification of Third Embodiment

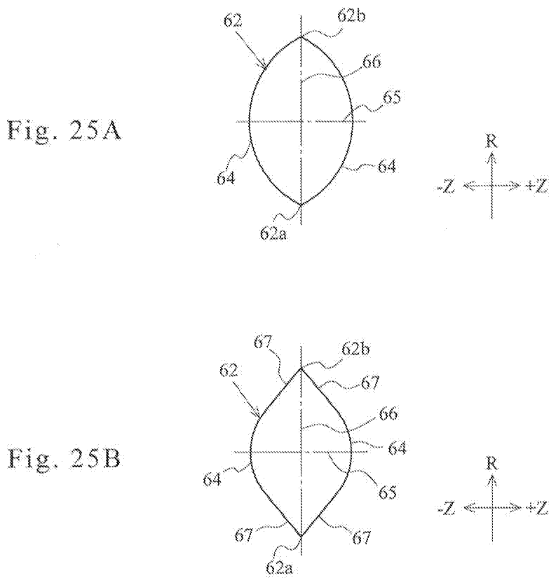

FIG. 25A is a diagram illustrating a first modification of the rolling trajectory 62 of the ball 6, and corresponding to FIG. 22C. The rolling trajectory 62 of the ball 6 shown in FIG. 25A is a pair of arcs 64, 64 facing each other to form a substantially elliptical shape, and has a line symmetry shape in which a center line 65 extending along the Z-axis direction is taken as a symmetry axis and also a line symmetry shape in which a center line 66 extending along the R direction is taken as a symmetry axis. The corrugated groove 60 of the ball type speed reducer 1 according to this embodiment may be formed to have the rolling trajectory 62 of the ball 6 shown in FIG. 25A.

### Second Modification of Third Embodiment

FIG. 25B is a diagram illustrating a second modification of the rolling trajectory 62 of the ball 6, and corresponding to FIG. 22C. The rolling trajectory 62 of the ball 6 shown in FIG. 25B is a pair of arc-like shapes facing each other to form a substantially elliptical shape in which both end sections of the arc 64 in FIG. 25A are replaced with straight lines 67, 67, and has a line symmetry shape in which a center line 65 extending along the Z-axis direction is taken as a symmetry axis and also a line symmetry shape in which a center line 66 extending along the R direction is taken as a symmetry axis. The corrugated groove 60 of the ball type speed reducer 1 according to this embodiment may be formed to have the rolling trajectory 62 of the ball 6 shown in FIG. 25B.

### Fourth Embodiment

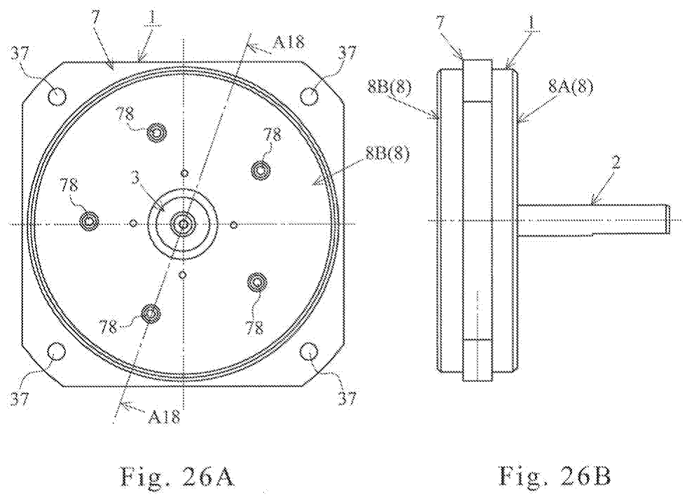

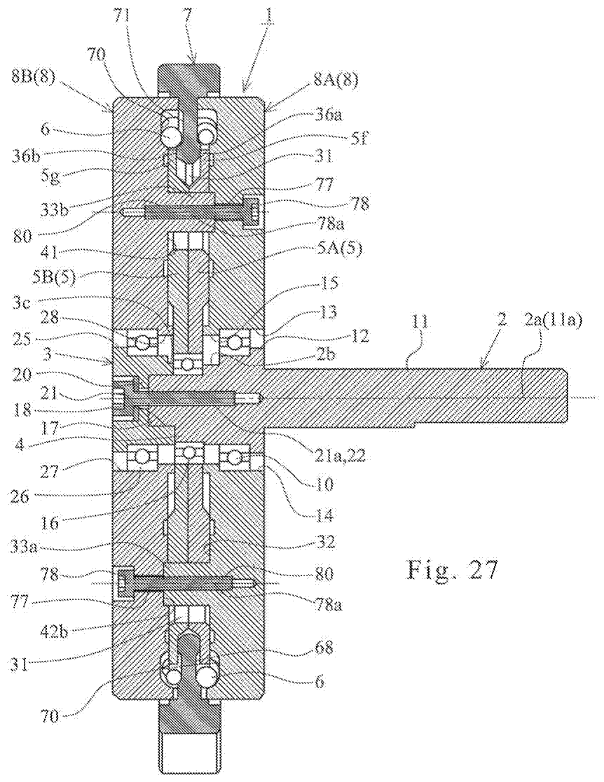

FIGS. 26A-27 are diagrams illustrating a ball type speed reducer 1 according to a fourth embodiment of the invention. Note that FIG. 26A is a front view illustrating the ball type speed reducer 1, and FIG. 26B is a side view illustrating the ball type speed reducer 1. FIG. 27 is a cross-sectional view taken along the line A18-A18 of FIG. 26A to illustrate the ball type speed reducer 1.

### Overall Structure

As illustrated in FIGS. 26A-27, the ball type speed reducer 1 according to this embodiment includes an input shaft (input-side rotating body) 2, a cap (input-side rotating body) 3, an eccentric disk cam 4, a shaking body 5 (a first shaking body 5A and a second shaking body 5B), a plurality of balls (steel balls) 6, a fixing member 7, an output-side rotating body 8 (a first output-side rotating body 8A and a second output-side rotating body 8B), and the like. FIG. 27 is a front view illustrating the ball type speed reducer 1 in which the cap 3, the second output-side rotating body 8B, and the like are removed.

### Input Shaft

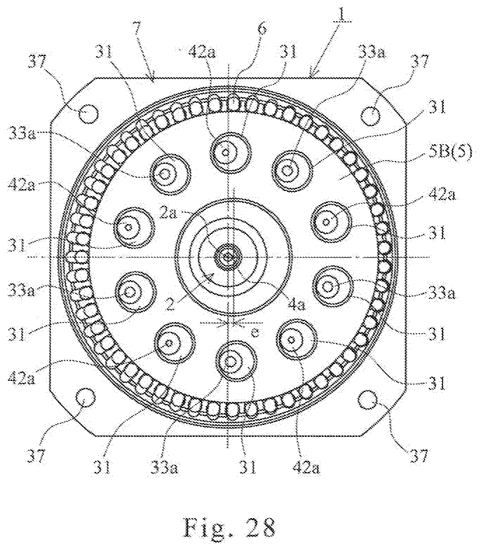

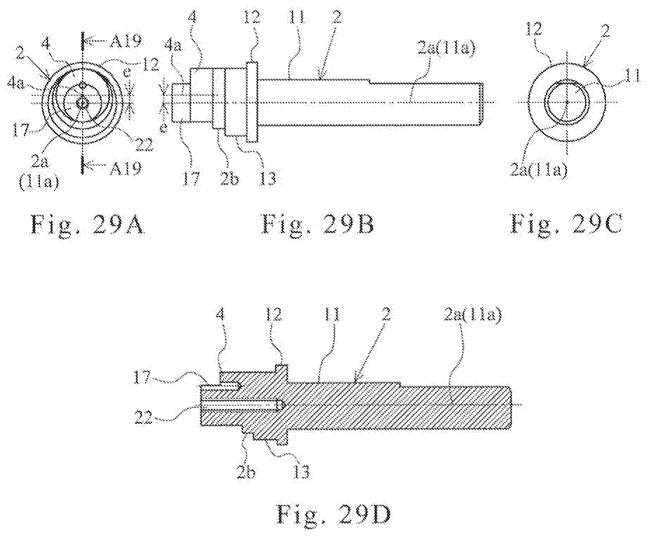

As illustrated in FIGS. 26A-29D, the input shaft 2 turnably supports the first output-side rotating body 8A by interposing a first bearing 10, so that the input shaft 2 is rotationally driven by a motor or the like (not shown). The input shaft 2 is formed such that a flange-like portion 12 having a diameter larger than that of a shaft body portion 11 is adjacent to the shaft body portion 11. A bearing support portion 13 is formed adjacent to the flange-like portion 12. The first bearing 10 is attached to the bearing support portion 13 to hold the first bearing 10 between an inner protrusion 15 of a bearing hole 14 of the first output-side rotating body 8A and the flange-like portion 12. Further, the input shaft 2 has the eccentric disk cam 4 formed closer to a shaft tip side than the bearing support portion 13 and in the vicinity of the bearing support portion 13. This eccentric disk cam 4 is a decentered shaft portion having a center 4a decentered from a rotation center 2a of the input shaft 2 (a rotation center 11a of the shaft body portion 11) by an eccentric amount “e,” and is eccentrically rotated integrally with the input shaft 2 by virtue of rotation of the rotation center 2a of the input shaft 2. In addition, the shaking body 5 is relatively turnably installed in the outer circumference side of the eccentric disk cam 4 by interposing a second bearing 16. Further, the input shaft 2 has a tip shaft portion 17 formed to install the cap 3. The tip shaft portion 17 has a rotation center concentric with the rotation center 2a of the shaft body portion 2 and fitted in a shaft hole 18 of the cap 3 and has a leading end face 17a abutting on a stopper protrusion 20 protruding into the shaft hole 18 of the cap 3. Further, in the tip shaft portion 17 of the input shaft 2, a screw hole (female screw) 22 to be screwed with a screw shaft portion 21a of a bolt 21 for fixing the cap 3 is formed.

### Cap

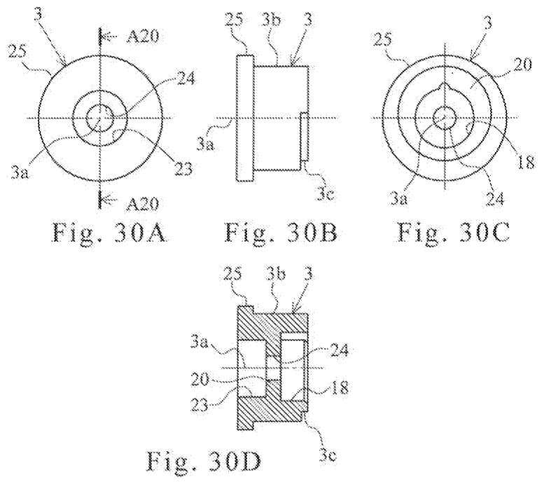

As shown in FIGS. 26A-26B, 27, and 30A-30D, the cap 3 is fixed to the tip shaft portion 17 of the input shaft 2 with the bolt 21, constitutes an input-side rotating body together with the input shaft 2, and has a rotation center 3a coinciding with the rotation center 2a. The cap 3 has the shaft hole 18 opened at one end side (right end side in FIG. 30D) along a rotation center 3a, a bolt head housing hole 23 opened at the other end side along the rotation center 3a (left end side in FIG. 30D), and a bolt shaft insertion hole 24 through which the bolt head housing hole 23 and the shaft hole 18 are communicated with each other. Further, the cap 3 has a ring-shaped bearing stopper 25 on the left end side of a cylindrical outer circumferential surface 3b. A side face of a third bearing 26 attached to the outer circumferential surface 3b abuts on the bearing stopper 25, so that the third bearing 26 is held between an inner protrusion 28 in the bearing hole 27 of the second output-side rotating body 8B and the bearing stopper 25. Note that, in the cap 3, the rotation center of the shaft hole 18 and the rotation center of the outer circumferential surface 3b are concentric with the rotation center 3a of the cap 3. Further, the cap 3 is formed to have an outer diameter of the outer circumferential surface 3b that is the same as the outer diameter of the bearing support portion 13 of the input shaft 2. In addition, the third bearing 26 attached to the outer circumferential surface 3b of the cap 3 as used is the same as the first bearing 10 attached to the bearing support portion 13 of the input shaft 2. Further, the cap 3 holds the second bearing 16 in a state where the second bearing 16 is positioned between a bearing positioning step 3c and a bearing positioning step 2b of the input shaft 2.

### Shaking Body

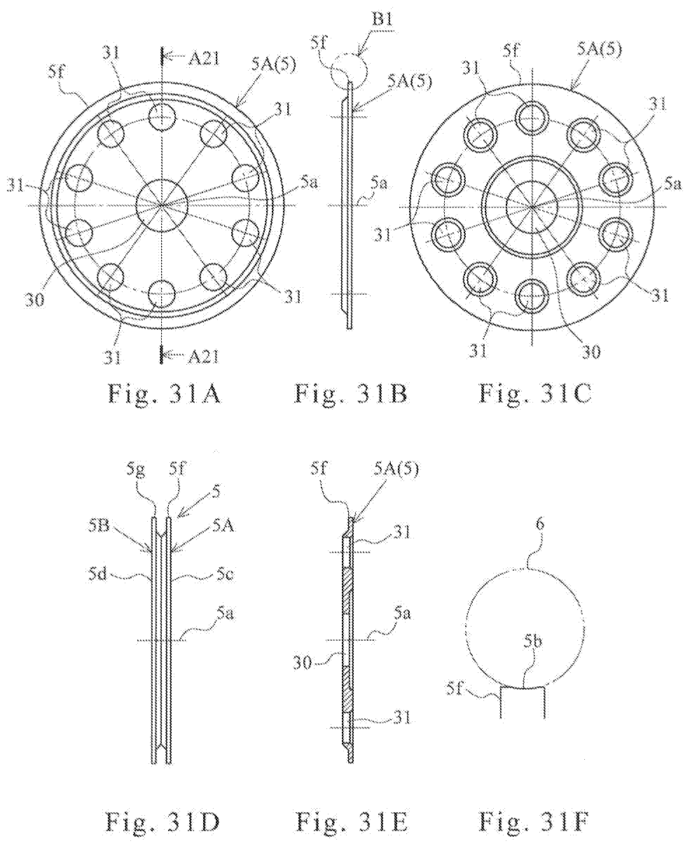

As shown in FIGS. 27 and 31A-31F, the shaking body 5 is obtained by combining the first shaking body 5A and the second shaking body 5B which are the same shape, back to back. The shaking body 5 is bifurcated into a first edge portion 5f (an outer circumferential edge portion of the first shaking body 5A) and a second edge portion 5g (an outer circumferential edge portion of the second shaking body 5B) on the outer circumferential end side. The first edge portion 5f is slidably engaged with one side face side of the fixing member 7, and the second edge portion 5g is slidably engaged with the other side face side of the fixing member 7. The first shaking body 5A is formed in a disk shape so as to be shaken by the eccentric disk cam 4, has a central bearing hole 30 fitted to the outer circumferential surface of the second bearing 16, and is supported by the second bearing 16 so as to be able to turn relative to the eccentric disk cam 4. In the first shaking body 5A, a center 5a is formed so as to be concentric with the center 4a of the eccentric disk cam 4, and an outer circumferential surface 5b is a cylindrical surface concentric with the center 4a of the eccentric disk cam 4. The plurality of balls 6 are rotatably supported at the outer circumferential surface 5b. Further, in the first shaking body 5A, ten through holes 31 are formed at equal intervals along the circumferential direction on an outer side of the radial direction of the bearing hole 30. The through hole 31 of the first shaking body 5A is engaged with a coupling protrusion 33a formed on a first side face portion 32 of the first output-side rotating body 8A and a coupling protrusion 33b formed on a second side face portion 41 of the second output-side rotating body 8B with a gap therebetween, and is formed to have a size such that the second through hole 31b does not contact the coupling protrusions 33a and 33b even when the first shaking body 5A is shaken by the eccentric disk cam 4. Further, the outer circumferential surface 5b of the first edge portion 5f of the first shaking body 5A has an arc-like cross-sectional shape that can come in line contact with the outer circumferential surface of the ball 5 (see FIG. 31F). Note that, since the second shaking body 5B has the same shape as the first shaking body 5A, the same parts as those of the first shaking body 5A will not be repeatedly described.

### Fixing Member

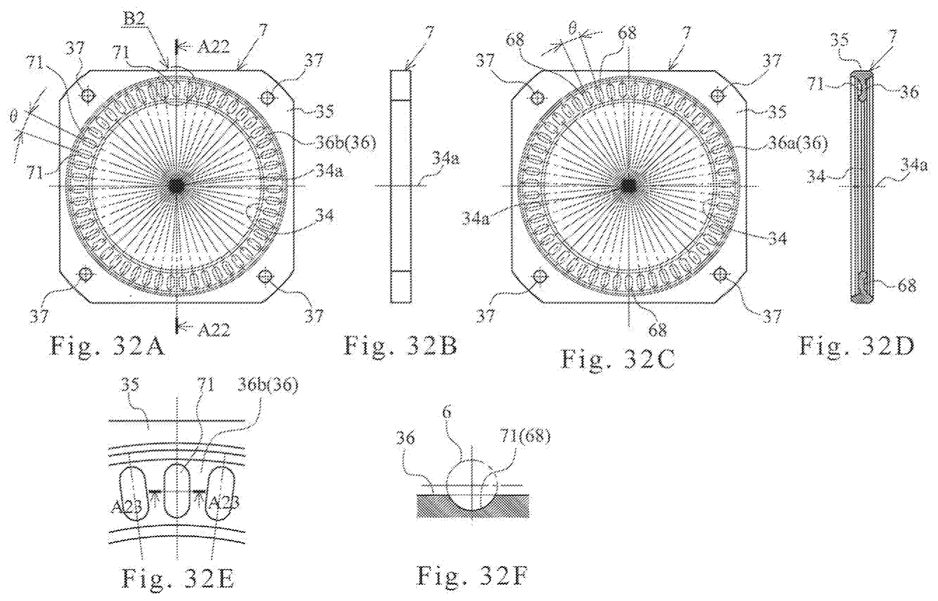

As shown in FIGS. 26A-28 and 32A-32F, the fixing member 7 has a substantially square shape on the front side, and a shaking body housing hole 34 is formed in its central portion. The fixing member 7 has a fixing frame portion 35 formed along the outer edge, and a radial groove forming disk portion 36 formed on the inner side of the radial direction of the fixing frame portion 35. In addition, in the fixing member 7, bolt holes 37 are formed at four corners of the fixing frame portion 35. Fixing bolts (not shown) are inserted into the bolt holes 37 in the four places, so that the fixing member 7 is fixed to a fixation target member (not shown) (for example, a machine frame or a robot arm) by the fixing bolts. The fixing member 7 is fixed to the fixation target member such that a center 34a of the shaking body housing hole 34 is concentric with the rotation center 2a of the input shaft 2. In addition, the shaking body 5 (the first shaking body 5A and the second shaking body 5B) is housed in the shaking body housing hole 34 of the fixing member 7 so as to be able to be shaken. The first edge portion 5f of the shaking body 5 (the outer circumferential edge portion of the first shaking body 5A) is disposed to face one side face 36a of the fixing member 7. Further, the second edge portion 5g of the shaking body 5 (the outer circumferential edge portion of the second shaking body 5B) is disposed to face the other side face 36b of the fixing member 7.

On one side face 36a of the radial groove forming disk portion 36 of the fixing member 7, a plurality of elongated hole-shaped first radial grooves 68 extending along the radial direction are formed along the circumferential direction at equal intervals (in “(N+1)” places when the number of waves of a corrugated groove 70 is set to “N”). Further, on the other side face 36b of the radial groove forming disk portion 36 of the fixing member 7, a plurality of elongated hole-shaped second radial grooves 71 extending along the radial direction are formed along the circumferential direction at equal intervals (in “(N+1)” places when the number of waves of the corrugated groove 70 is set to “N”). In addition, the second radial grooves 71 are formed at positions when the first radial grooves 68 are deviated by a half pitch in the circumferential direction (an angle of θ/2 where θ is the angle between the adjacent first radial grooves 68, 68) so that the first radial grooves 68 are turned upside down, and are also formed at the same positions in the radial direction as the first radial grooves 68. The first radial groove 68 and the second radial groove 71 are formed such that their groove depth is smaller than the radius of the ball 6 and their groove shape has an arc shape with the same radius as the radius of the ball 6, and are also formed in line contact with the balls 6. Further, the first radial groove 68 and the second radial groove 71 are formed to have a groove length (length in the radial direction) which is a length taking into consideration the amount of shaking of the shaking body 5 (an eccentric amount “e” of the eccentric disk cam 4), so that the ball 6 supported at the outer circumferential surface 5b of the shaking body 5 is slidably moved along the radial direction. Further, the ball 6 housed in the first radial groove 68 is rollably engaged with the corrugated groove 70 of the first output-side rotating body 8A. Further, the ball 6 housed in the second radial groove 71 is rollably engaged with the corrugated groove 70 of the second output-side rotating body 8B. Such first radial grooves 68 and second radial grooves 71 of the fixing member 7 can roll the balls 6 in the radial direction depending on a shake amount of the shaking body 5 as the eccentric disk cam 4 rotates by one turn, and the shaking body 5 is shaken by one stroke.

In the fixing member 7 configured as described above, the first radial groove 68 formed on one side face 36a of the radial groove forming disk portion 36 and the second radial groove 71 formed on the other side face 36b are deviated from each other in the circumferential direction by a half pitch (angle of θ/2). Therefore, compared to the case where the first radial groove 68 and the second radial groove 71 are formed at the same position in the circumferential direction (the case where they are not deviated from each other in the circumferential direction), the thickness of the radial groove forming disk portion 36 can be sufficiently secured, and the strength of the radial groove forming disk portion 36 can be increased. Further, in the fixing member 7, the first radial groove 68 formed on one side face 36a and the second radial groove 71 formed on the other side face 36b are deviated from each other in the circumferential direction by a half pitch. Therefore, compared to the case where the first radial groove 68 and the second radial groove 71 are formed at the same position in the circumferential direction (the case where they are not deviated from each other in the circumferential direction), the thickness of the radial groove forming disk portion 36 can be reduced while the strength of the radial groove forming disk portion 36 is maintained constant, thereby making it possible to achieve a light weight.

### First Output-Side Rotating Body

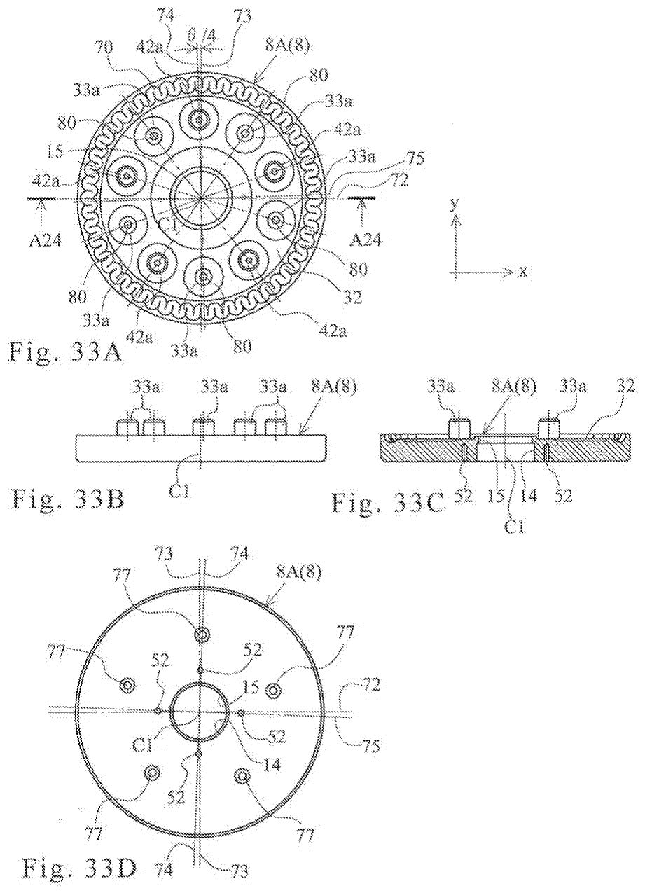

As shown in FIGS. 26A-27, and 33A-33D, the first output-side rotating body 8A has the first side face portion 32 placed to face one side face 5c of both side faces 5c and 5d of the shaking body 5, and one side face 36a of both side faces 36a and 36b of the radial groove forming disk portion 36 of the fixing member 7. Further, in the first output-side rotating body 8A, the bearing hole 14 for housing the first bearing 10 attached to the input shaft 2 is formed, so that the side face of the outer race of the first bearing 10 abuts on the inner protrusion 15 formed at the end of the bearing hole 14. In the first side face portion 32 of the first output-side rotating body 8A, a plurality of coupling protrusions 33a for coupling and fixing the second output-side rotating body 8B are formed at equal intervals (in five places) in the circumferential direction. The coupling protrusion 33a is inserted into the through hole 31 of the shaking body 5 so as to be fitted in a coupling protrusion housing recess 42b formed on a second side face portion 41 of the second output-side rotating body 8B. Further, in the first side face portion 32 of the first output-side rotating body 8A, a plurality of coupling protrusion housing recesses 42a for coupling and fixing the second output-side rotating body 8B are formed at equal intervals (in five places) in the circumferential direction. A coupling protrusion 33b is formed extending through the through hole 31 of the shaking body 5 on the second side face portion 41 of the second output-side rotating body 8B so as to be fitted in the coupling protrusion housing recess 42a. The coupling protrusion 33a and the coupling protrusion housing recess 42a are alternately arranged at equal intervals around a center C1 of the first output-side rotating body 8A. Further, in the first side face portion 32 of the first output-side rotating body 8A, the corrugated groove 70 is formed on the outer side of the radial direction of the coupling protrusion 33a and the coupling protrusion housing recess 42a. As shown in FIG. 33A, 50 waves are continuously formed in the corrugated groove 70. When the radial inner end of a wave is referred to as a bottom and the radial outer end of the wave is referred to as a top, the corrugated groove 70 is formed such that the top of the wave is placed on a center line 72 which passes through the center C1 of the first output-side rotating body 8A and is parallel to the x direction. In addition, one of the coupling protrusions 33a and one of the coupling protrusion housing recesses 42a located at a two-fold symmetrical position with the one of the coupling protrusions 33a are arranged on a center line 74 which is deviated counterclockwise by a ¼ pitch (an angle of θ/4 where θ is the angle between the adjacent first radial grooves 68, 68) of the first radial groove 68 with respect to a center line 73 (center line passing through the center C1 of the first output-side rotating body 8A and parallel to the y direction) perpendicular to the center line 72.

Further, on the back face side of the first output-side rotating body 8A (face side placed opposite to the first side face portion 32), screw holes 52 for fixing a fixation target member are formed in four places at equal intervals along the circumferential direction closer to the inner side in the radial direction than the coupling protrusion 33a. The screw holes 52 are formed at a pair of positions on the center line 74, and are formed at a pair of positions on a center line 75 perpendicular to the center line 74.

Further, in the first side face portion 32 of the first output-side rotating body 8A, the radial groove forming disk portion 36 of the fixing member 7, the first edge portion 5f of the shaking body 5, and the second edge portion 5g of the shaking body 5 are housed between the second side face portion 41 of the second output-side rotating body 8B and a portion radially inward of the corrugated groove 70 (more precisely, a region which enables the shaking body 5 to shake). On the other hand, in the first side face portion 32 of the first output-side rotating body 8A, only the radial groove forming disk portion 36 of the fixing member 7 is housed between the second side face portion 41 of the second output-side rotating body 8B and a portion radially outward of the corrugated groove 70 (more precisely, a region where the outer circumferential end of the shaking body 5 does not reach). Therefore, in the first side face portion 32 of the first output-side rotating body 8A, since the corrugated groove 70 is formed such that the groove depth of the first radial groove 68 formed on one side face 36a of the fixing member 7 is smaller than the radius of the ball 6, the groove depth on the top side can be made larger than the radius of the ball 6. As a result, the first output-side rotating body 8A can effectively prevent the ratcheting in the vicinity of the top of the corrugated groove 70 where the largest rotational torque acts when the rotation of the ball type speed reducer 1 is transmitted.

### Second Output-Side Rotating Body

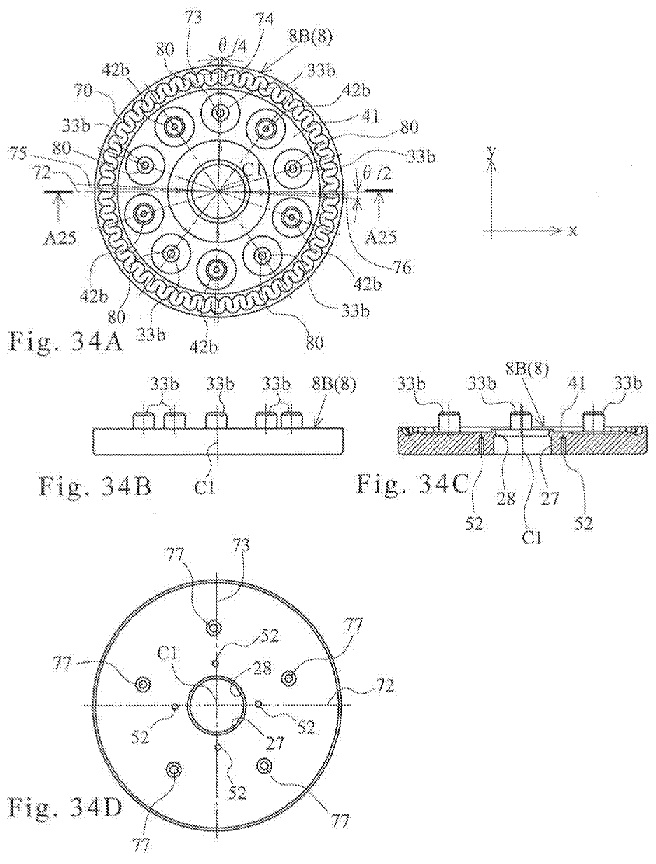

FIGS. 34A-34D are diagrams illustrating the second output-side rotating body 8B. The second output-side rotating body 8B shown in FIG. 34A is obtained in such a manner that the first output-side rotating body 8A is turned upside down around the center line (reversal reference center line) 72 of FIG. 33A, then the first output-side rotating body 8A is rotated 180 degrees around the center line 73, and subsequently the first output-side rotating body 8A is rotated clockwise around the center C1 of the first output-side rotating body 8A by a half pitch of the second radial groove 71 (an angle of θ/2 where θ is the angle between the adjacent radial grooves 71, 71). The second output-side rotating body 8B as used has the same shape as the first output-side rotating body. The second output-side rotating body 8B has the second side face portion 41 placed to face the other side face 5d of both the side faces 5c and 5d of the shaking body 5, and the other side face 36b of both the side faces 36a and 36b of the radial groove forming disk portion 36 of the fixing member 7. In the second side face portion 41 of the second output-side rotating body 8B, a plurality of coupling protrusion housing recesses 42b fitted to the coupling protrusions 33 are formed as many as the coupling protrusions 33a at positions corresponding to the respective coupling protrusions 33a of the first output-side rotating body 8a. Further, in the second side face portion 41 of the second output-side rotating body 8B, a plurality of coupling protrusions 33b fitted to the coupling protrusion housing recesses 42a are formed as many as the coupling protrusion housing recesses 42a at positions corresponding to the respective coupling protrusion housing recesses 42a of the first output-side rotating body 8A. Further, in the second output-side rotating body 8B, the bearing hole 27 for housing the third bearing 26 attached to the cap 3 is formed, so that the side face of the outer race of the third bearing 26 abuts on the inner protrusion 28 formed at the end of the bearing hole 27. Further, on the back face side of the second output-side rotating body 8B (face side placed opposite to the second side face portion 41), screw holes 52 for fixing a fixation target member are formed in four places at equal intervals along the circumferential direction closer to the inner side in the radial direction than the coupling protrusion 33b.

Further, in the second side face portion 41 of the second output-side rotating body 8B, the corrugated groove 70 is formed on the outer side of the radial direction of the coupling protrusion 33b and the coupling protrusion housing recess 42b. As shown in FIG. 34A, 50 waves are continuously formed in the corrugated groove 70. The corrugated groove 70 is formed such that the top of the wave is placed on a center line 76 rotated clockwise by θ/2 from the center line 72 which passes through the center C1 of the second output-side rotating body 8B and is parallel to the x direction. In addition, one of the coupling protrusions 33b and one of the coupling protrusion housing recesses 42b located at a two-fold symmetrical position with the one of the coupling protrusions 33b are arranged on the center line 74 perpendicular to the center line 75.

Note that the first output-side rotating body 8A and the second output-side rotating body 8B are fixed in such a manner that a shaft portion 78a of a bolt 78 inserted into a bolt hole 77 formed in the coupling protrusion housing recess 42b of the second output-side rotating body 8B is screwed into a female screw portion 80 of the coupling protrusion 33a of the first output-side rotating body 8A; a shaft portion 78a of a bolt 78 inserted into a bolt hole 77 formed in the coupling protrusion housing recess 42a of the first output-side rotating body 8A is screwed into a female screw portion 80 of the coupling protrusion 33b of the second output-side rotating body 8B.

Further, in the second side face portion 41 of the second output-side rotating body 8B, the radial groove forming disk portion 36 of the fixing member 7, the first edge portion 5f of the shaking body 5, and the second edge portion 5g of the shaking body 5 are housed between the first side face portion 32 of the first output-side rotating body 8A and a portion radially inward of the corrugated groove 70 (more precisely, a region which enables the shaking body 5 to shake). On the other hand, in the second side face portion 41 of the second output-side rotating body 8B, only the radial groove forming disk portion 36 of the fixing member 7 is housed between the first side face portion 32 of the first output-side rotating body 8A and a portion radially outward of the corrugated groove 70 (more precisely, a region where the outer circumferential end of the shaking body 5 does not reach). Therefore, in the second side face portion 41 of the second output-side rotating body 8B, since the corrugated groove 70 is formed such that the groove depth of the second radial groove 71 formed on the other side face 36b of the fixing member 7 is smaller than the radius of the ball 6, the groove depth on the top side can be made larger than the radius of the ball 6. As a result, the second output-side rotating body 8B can effectively prevent the ratcheting in the vicinity of the top of the corrugated groove 70 where the largest rotational torque acts when the rotation of the ball type speed reducer 1 is transmitted.

### Operating State

As shown in FIGS. 27 and 33A-34D, in the ball type speed reducer 1 according to this embodiment, when the first output-side rotating body 8A and the second output-side rotating body 8B are combined to be fixed, the corrugated groove 70 of the first output-side rotating body 8A and the corrugated groove 70 of the second output-side rotating body 8B are placed to be deviated from each other by a half pitch (θ/2) of the first radial groove 68 (or the second radial groove 71) in the circumferential direction. Therefore, even when the first radial groove 68 and the second radial groove 71 of the fixing member 7 are formed to be deviated from each other by a half pitch (θ/2) in the circumferential direction, the positional relationship between the first radial groove 68 of the fixing member 7 and the corrugated groove 70 of the first output-side rotating body 8A matches the positional relationship between the second radial groove 71 of the fixing member 7 and the corrugated groove 70 of the second output-side rotating body 8B, thereby making it possible to achieve smooth rotation transmission.

### Advantageous Effects of this Embodiment

In the ball type speed reducer 1 according to this embodiment configured as described above, since the corrugated grooves 70 are formed only in two places: the first side face portion 32 of the first output-side rotating body 8A and the second side face portion 41 of the second output-side rotating body 8B, it is possible to reduce the man-hours, compared to the ball type speed reducer 100 of the prior art (see FIGS. 35A and 35B) in which the corrugated grooves 111, 111, 112, and 112 are formed in four places. Further, in the ball type speed reducer 1 according to this embodiment, the shaking body 5 can be shaken independently from the fixing member 7 and the output-side rotating body 8 (the first output-side rotating body 8A and the second output-side rotating body 8B). Therefore, it is not necessary to provide a complicated mechanism for turning the shaking body 5 and the output-side rotating body 8 integrally (for example, the eccentricity absorption mechanism 113, 113 of the ball type speed reducer 100 in the prior art shown in FIGS. 35A and 35B). Accordingly, it is possible to simplify the structure and reduce the man-hours.

Further, in the ball type speed reducer 1 according to this embodiment, the balls 6 are positioned in a portion where the first radial groove 68 and the corrugated groove 70 intersect and in a portion where the second radial groove 71 and the corrugated groove 70 intersect. Therefore, compared to the ball type speed reducer 100 of the prior art in which the balls 108 simultaneously come into contact with the groove wall of the first corrugated groove 111 of the eccentric rotating plate 104 and the groove wall of the second corrugated groove 112 of the fixing member 107 (see FIGS. 35A and 35B), it is possible to facilitate machining of the first radial groove 68, the second radial groove 71, and the corrugated groove 70, and an assembly work for the shaking body 5, the fixing member 7, the output-side rotating body 8 (the first output-side rotating body 8A and the second output-side rotating body 8B), and the like.

Further, in the ball type speed reducer 1 according to the this embodiment, the first output-side rotating body 8A and the second output-side rotating body 8B have the same shape, so that their parts (the first output-side rotating body 8A, the second output-side rotating body 8B, the first bearing 10, and the third bearing 26) can be made common, thereby making it possible to reduce the parts cost.

### Modification of this Embodiment

Note that, in the ball type speed reducer 1 according to this embodiment, the first radial groove 68 and the second radial groove 71 of the fixing member 7 are formed to be deviated from each other by a half pitch (θ/2) along the circumferential direction. However, without limiting thereto, the first radial groove 68 and the second radial groove 71 of the fixing member 7 may be formed at the same position in the circumferential direction. Note that, with such a configuration of the fixing member 7, one of the coupling protrusions 33a of the first output-side rotating body 8A and one of the coupling protrusion housing recesses 42a located at a two-fold symmetrical position with the one of the coupling protrusions 33a are arranged on the center line 73 (the center line passing through the center C1 of the first output-side rotating body 8A and parallel to the y direction).

Further, in the ball type speed reducer 1 according to this embodiment, the shaking body 5 is obtained by combining the first shaking body 5A and the second shaking body 5B which are the same shape, back to back. However, without limiting thereto, the shaking body 5 may be integrally formed as a whole.

### Modifications of First to Fourth Embodiments

In the ball type speed reducers 1 according to the first to fourth embodiments of the invention, a ball bearing, a roller bearing, a bush or the like is used as the first to third bearings 10, 16, and 26.

Further, in the ball type speed reducers 1 of the first to fourth embodiments of the invention, the entire assembly of the speed reducer (including the input shaft 2, the cap 3, the shaking body 5, the fixing member 7, the first output-side rotating body 8A, the second output-side rotating body 8B, and the like) may be formed of metal, a part of the assembly may be formed of a synthetic resin material, or the entire assembly except for the first to fourth bearings 10, 16, and 26 and the balls 6 may be formed of a synthetic resin material. In particular, in the ball type speed reducer 1 in which the entire assembly except for the first to third bearings 10, 16, and 26 and the balls 6 is formed of a synthetic resin material, it is possible to reduce the weight and lower the product cost. Further, in the ball type speed reducer 1 in which the entire assembly except for the first to third bearings 10, 16, and 26 and the balls 6 is formed of a synthetic resin material, it is possible to reduce a contact sound of the ball 6 (noise reduction) and suppress vibration. Furthermore, in the ball type speed reducers 1 according to the third and fourth embodiments, in the case where the entire assembly except for the first to third bearings 10, 16, and 26 and the balls 6 is formed of a synthetic resin material, the first output-side rotating body 8A and the second output-side rotating body 8B can be made common, and accordingly one die is enough to injection molding, thereby making it possible to reduce the manufacturing cost.

### REFERENCE SIGNS LIST

1 ball type speed reducer,
2 input shaft (input-side rotating body),
2a rotation center,
3 cap (input-side rotating body),
4 eccentric disk cam,
4a center,
5 shaking body,
5b outer circumferential surface,
6 ball,
7 fixing member,
8 output-side rotating body,
8A first output-side rotating body
8B second output-side rotating body,
32 first side face portion,
38 radial groove,
40, 56, 60 corrugated groove,
40a, 60a bottom,
40b, 60b top,
41 second side face portion

1. A ball type speed reducer that decelerates and transmits rotation of an input-side rotating body to an output-side rotating body, comprising:
an eccentric disk cam that turns integrally with the input-side rotating body;
a shaking body fitted relatively turnably to an outer circumference side of the eccentric disk cam and shaken by the eccentric disk cam;
a plurality of balls disposed along an outer circumferential surface of the shaking body;
a fixing member that houses the shaking body in an inner side of a radial direction such that the shaking body is shakable, the fixing member being fixed to a fixation target member;
a first output-side rotating body disposed to face one side face of the shaking body and the fixing member and relatively turnably supported by the input-side rotating body; and
a second output-side rotating body disposed to face the other side face of the shaking body and the fixing member and integrally turnably fixed to the first output-side rotating body, and relatively turnably supported by the input-side rotating body and constituting the output-side rotating body together with the first output-side rotating body,
wherein the outer circumferential surface of the shaking body is a cylindrical surface concentric with a center of the eccentric disk cam,
when a direction extending radially from a rotation center of the input-side rotating body is set as a radial direction on a virtual plane perpendicular to the rotation center, the fixing member has a plurality of radial grooves as many as the balls formed to slidably guide the balls in the radial direction, and radial inner ends of the radial grooves are open ends allowing the balls to enter and exit,
the first output-side rotating body has a first side face portion opposed to one side face of the fixing member,
the second output-side rotating body has a second side face portion opposed to the other side face of the fixing member, and
when a direction extending along an outer edge of a virtual circle centered at the rotation center on the virtual plane is set as a circumferential direction, the first side face portion and the second side face portion each have an annular corrugated groove formed to spirally guide the balls along the circumferential direction.

2. The ball type speed reducer according to claim 1, wherein
the corrugated groove is formed to have an even number of waves continuously formed such that when a radial inner end of the wave is a bottom and a radial outer end of the wave is a top, the bottom is placed across the first side face portion and the second side face portion, the top of odd-numbered waves is formed to have a groove depth such that any one side of the first side face portion and the second side face portion is deeper than the other side of the first side face portion and the second side face portion, the top of even-numbered waves is formed to have a groove depth such that the other side of the first side face portion and the second side face portion is deeper than the one side of the first side face portion and the second side face portion, and the groove depth is formed to gradually increase from the bottom toward the top.

3. The ball type speed reducer according to claim 2, wherein
when the number of waves of the corrugated groove is set to “N,” the number of grooves in the radial grooves is “(N+1)/3,” where “N” is an even number and “(N+1)/3” is a natural number.

4. The ball type speed reducer according to claim 2, wherein
when the number of waves of the corrugated groove is set to “N,” the number of grooves in the radial grooves is “(N−1)/3,” where “N” is an even number and “(N−1)/3” is a natural number.

5. The ball type speed reducer according to claim 1, wherein
the corrugated groove is formed to have waves such that when a radial inner end of the wave is a bottom and a radial outer end of the wave is a top, the first side face portion and the second side face portion at each of the bottom and the top have an equal groove depth, the groove depth of any one of the first side face portion and the second side face portion gradually increases from the bottom toward the top and then gradually decreases, the groove depth of the other one of the first side face portion and the second side face portion gradually decreases from the bottom toward the top and then gradually increases, the groove depth of the one of the first side face portion and the second side face portion gradually decreases from the top toward the bottom and then gradually increases, and the groove depth of the other one of the first side face portion and the second side face portion gradually increases from the top toward the bottom and then gradually decreases.

6. The ball type speed reducer according to claim 5, wherein
a shape of the corrugated groove projected on a virtual cross section perpendicular to the virtual plane and including the rotation center of the input-side rotating body is an elliptical shape or a substantially elliptical shape.

7. A ball type speed reducer that decelerates and transmits rotation of an input-side rotating body to an output-side rotating body, comprising:
an eccentric disk cam that turns integrally with the input-side rotating body;
a shaking body fitted relatively turnably to an outer circumference side of the eccentric disk cam and shaken by the eccentric disk cam;
a plurality of balls disposed along an outer circumferential surface of the shaking body;
a fixing member that houses the shaking body in an inner side of a radial direction such that the shaking body is shakable, the fixing member being fixed to a fixation target member;
a first output-side rotating body disposed to face one side face of the shaking body and the fixing member and relatively turnably supported by the input-side rotating body; and
a second output-side rotating body disposed to face the other side face of the shaking body and the fixing member and integrally turnably fixed to the first output-side rotating body, and relatively turnably supported by the input-side rotating body and constituting the output-side rotating body together with the first output-side rotating body,
wherein the outer circumferential surface of the shaking body is a cylindrical surface concentric with a center of the eccentric disk cam,
when a direction extending radially from a rotation center of the input-side rotating body is set as a radial direction on a virtual plane perpendicular to the rotation center, the fixing member has a plurality of radial grooves as many as the balls formed at each of the one side face and the other side face to slidably guide the balls in the radial direction,
the first output-side rotating body has a first side face portion opposed to one side face of the fixing member,
the second output-side rotating body has a second side face portion opposed to the other side face of the fixing member, and
when a direction extending along an outer edge of a virtual circle centered at the rotation center on the virtual plane is set as a circumferential direction, the first side face portion and the second side face portion each have an annular corrugated groove formed to guide the balls along the circumferential direction.

8. The ball type speed reducer according to claim 7, wherein
the ball housed in the radial groove formed on the one side face of the fixing member engages with the corrugated groove formed on the first side face portion of the first output-side rotating body,
the ball housed in the radial groove formed on the other side face of the fixing member engages with the corrugated groove formed on the second side face portion of the second output-side rotating body, and
when the corrugated groove has waves in which a radial inner end of the wave is a bottom and a radial outer end of the wave is a top, a groove depth of the top is larger than a radius of the ball.

9. The ball type speed reducer according to claim 7, wherein
an outer circumferential end of the shaking body is bifurcated into a first end portion and a second end portion,
the first end portion is slidably engaged with the one side of the fixing member, and
the second end portion is slidably engaged with the other side of the fixing member.

10. The ball type speed reducer according to claim 8, wherein
an outer circumferential end of the shaking body is bifurcated into a first end portion and a second end portion,
the first end portion is slidably engaged with the one side of the fixing member, and
the second end portion is slidably engaged with the other side of the fixing member.
